(19) United States
(12) Patent Application Publication
(10) Pub. No.: US 2024/0415199 A1
(43) Pub. Date: Dec. 19, 2024

(54) AEROSOL GENERATING DEVICE AND OPERATING METHOD THEREOF

(71) Applicant: KT&G CORPORATION, Daejeon (KR)

(72) Inventors: Hyung Jin JUNG, Seoul (KR); Tae Hun KIM, Yongin-si (KR); Ju Eon PARK, Seongnam-si (KR); Youn Ji SHIN, Seoul (KR); Hun II LIM, Seoul (KR)

(73) Assignee: KT&G CORPORATION, Daejeon (KR)

(21) Appl. No.: 18/742,583

(22) Filed: Jun. 13, 2024

(30) Foreign Application Priority Data
Jun. 19, 2023 (KR) 10-2023-0078217
Aug. 11, 2023 (KR) 10-2023-0105546

(51) Int. Cl. A24F 40/57; A24F 40/10; A24F 40/42; A24F 40/51; A24F 40/53; H05B 1/02

(52) U.S. Cl. CPC A24F 40/57; A24F 40/10; A24F 40/42; A24F 40/51; A24F 40/53; H05B 1/0297

(57) ABSTRACT

An aerosol generating device includes a main body including a processor, and a cartridge detachably coupled to the main body, wherein the cartridge includes a reservoir storing an aerosol generating material, a heating structure configured to heat the aerosol generating material, and a wick configured to supply the aerosol generating material stored in the reservoir to the heating structure, and the processor compares a first temperature of the heating structure with a preset threshold, stops power supply to the heating structure based on the first temperature being greater than or equal to the preset threshold, compares a second temperature of the heating structure detected after the power supply is stopped with the preset threshold, and supplies power to the heating structure based on the second temperature being less than the preset threshold. In addition to this, various embodiments identified through the specification may be provided.

### CROSS-REFERENCE TO RELATED APPLICATION

This application is based on and claims priority under 35 U.S.C. § 119 to Korean Patent Application No. 10-2023-0078217, filed on Jun. 19, 2023, and Korean Patent Application No. 10-2023-0105546, filed on Aug. 11, 2023, in the Korean Intellectual Property Office, the disclosures of which are incorporated by reference herein in their entireties.

### BACKGROUND

### 1. Field

Embodiments relate to an aerosol generating device that controls heating based on an internal state of a cartridge and an operating method of the aerosol generating device.

### 2. Description of the Related Art

Recently, there has been an increasing demand for alternative methods of solving the disadvantages of general cigarettes. For example, there is an increasing demand for systems that generate aerosols by heating cigarettes or aerosol generating materials by using aerosol generating devices, rather than methods of generating aerosols by burning cigarettes.

The use of electronic cigarettes, which generate aerosols by heating liquid compositions including aerosol generating materials, is gradually increasing. The liquid compositions within cartridges may be supplied to wicks through preset paths, and as the wicks are heated by heaters, aerosols may be generated.

Recently, research has been actively conducted on methods of detecting the depletion of liquid compositions in cartridges and the remaining amount of the liquid compositions in the cartridges. In particular, when heating continues while liquid compositions in cartridges are depleted, all the aerosol generating materials impregnated in wicks are vaporized, and accordingly, only dry wicks other than aerosol generating materials may be heated. In this case, although aerosol generating materials are vaporized, aerosols are not generated, and as wicks and/or foreign materials are heated, an undesirable flavor of burnt smoke may be provided to a user. Accordingly, aerosol generating devices may determine whether a liquid composition in a cartridge is depleted, and when the liquid composition is depleted, the power supply to a heater may be stopped to prevent further heating.

### SUMMARY

An aerosol generating device determines whether a liquid composition is depleted according to the temperature of a heater adjacent to a wick, and accordingly, even when the liquid composition in a cartridge is not depleted, the aerosol generating device may determine that the liquid composition is depleted. For example, when the liquid composition is not temporarily supplied to the wick in the cartridge, the temperature of a heater may momentarily increase, and accordingly, the aerosol generating device determines that the liquid composition is depleted and may stop power supply to the heater.

In this case, smoking is forcibly terminated despite the number of puffs remains, and thus, a user may feel uncomfortable.

Various embodiments provide an aerosol generating device that may determine an internal state of a cartridge based on the temperature of a heater and controls power supply to the heater based on the determined internal state.

The problems to be solved through embodiments are not limited to the above-described problems, and the problems not mentioned will be clearly understood by those skilled in the art to which the embodiments belong, from the description and accompanying drawings.

Additional aspects will be set forth in part in the description which follows and, in part, will be apparent from the description, or may be learned by practice of the presented embodiments of the disclosure.

According to an embodiment, an aerosol generating device includes a main body including a processor, and a cartridge detachably coupled to the main body, wherein the cartridge includes a reservoir storing an aerosol generating material, a heating structure configured to heat the aerosol generating material, and a wick configured to supply the aerosol generating material stored in the reservoir to the heating structure, and the processor is configured to compare a first temperature of the heating structure with a preset threshold, stop power supply to the heating structure based on the first temperature being greater than or equal to the preset threshold, compare a second temperature of the heating structure detected after the power supply is stopped with the preset threshold, and supply power to the heating structure based on the second temperature that is less than the preset threshold.

According to another embodiment, an aerosol generating device includes a main body including a processor, and a cartridge detachably coupled to the main body, wherein the cartridge includes a reservoir storing an aerosol generating material, a heating structure configured to heat the aerosol generating material, and a wick configured to supply the aerosol generating material stored in the reservoir to the heating structure, and the processor is configured to compare a temperature change amount of the heating structure with a preset threshold change amount, stop power supply to the heating structure based on the temperature change amount being greater than or equal to the preset threshold change amount, compare a temperature of the heating structure detected after the power supply is stopped with a preset threshold, and supply power to the heating structure based on the temperature being less than the preset threshold.

According to another embodiment, an operating method of an aerosol generating device includes comparing, by a processor included in a main body, a first temperature of a heating structure for heating an aerosol generating material in a cartridge detachably coupled to the main body with a preset threshold, stopping, by the processor, power supply to the heating structure based on the first temperature being greater than or equal to the preset threshold, comparing, by the processor, a second temperature of the heating structure detected after the power supply is stopped with the preset threshold, and supplying, by the processor, power to the heating structure based on the second temperature being less than the preset threshold.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an aerosol generating device according to an embodiment;

FIG. 2 is a diagram illustrating an aerosol generating device according to another embodiment;

FIG. 3 is a front perspective view of an aerosol generating device according to an embodiment;

FIG. 4 is a perspective view of a combined body, cartridge, and cap of an aerosol generating device according to an embodiment;

FIG. 5 is a cross-sectional view of an aerosol generating device according to an embodiment;

FIG. 6 is a front perspective view of an aerosol generating device according to another embodiment;

FIG. 7 is a perspective view of a combined body, cartridge, and cap of an aerosol generating device according to another embodiment;

FIG. 8 is an exploded perspective view of a cartridge of an aerosol generating device according to another embodiment;

FIG. 9 is a cross-sectional view of a cartridge of an aerosol generating device according to another embodiment;

FIG. 10 is a cross-sectional view of an aerosol generating device according to another embodiment;

FIG. 11 is a cross-sectional view of an aerosol generating device according to an embodiment;

FIG. 12 is a flowchart illustrating a method of controlling power supply of an aerosol generating device, according to an embodiment;

FIG. 13 is a cross-sectional view of a cartridge according to an embodiment;

FIG. 14 is a flowchart illustrating an example in which an aerosol generating device controls power supply, according to an embodiment;

FIG. 15 is a graph illustrating a method used by an aerosol generating device to control power supply, according to a first embodiment;

FIG. 16 is a graph illustrating a method used by an aerosol generating device to control power supply, according to a second embodiment;

FIG. 17 is a flowchart illustrating another example in which an aerosol generating device controls power supply, according to an embodiment;

FIG. 18 is a block diagram illustrating a coupling relationship between a main body and cartridge of an aerosol generating device according to an embodiment; and

FIG. 19 is a block diagram of an aerosol generating device according to an embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted.

The suffixes “module”, “-er”, and “-or” for the components used in the following description are given or used interchangeably by considering only the ease of writing the description, and do not have distinct meanings or roles in themselves.

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to” another element, there are no intervening elements present.

The singular forms are intended to include the plural forms as well, unless the context clearly indicates otherwise.

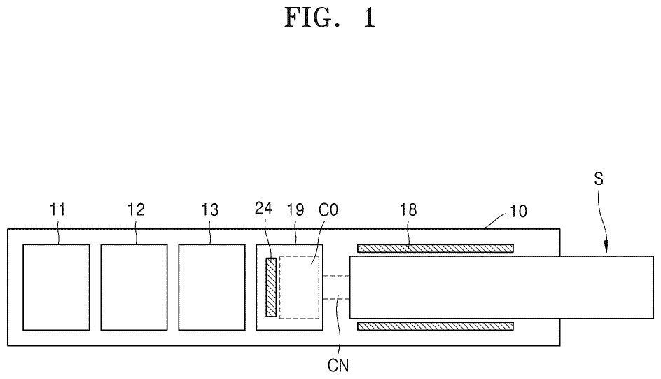

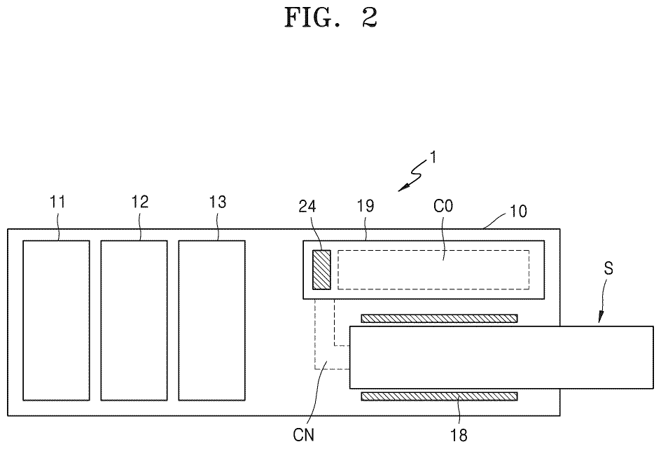

FIGS. 1 and 2 illustrate an aerosol generating device 1 according to embodiments.

Referring to FIG. 1, the aerosol generating device 1 may include at least one of a power source 11, a controller 12, a sensor 13, a heater 18, and a cartridge 19. At least one of the power source 11, the controller 12, the sensor 13, and the heater 18 may be arranged inside a body 10 of the aerosol-generating device 1. The body 10 may provide a space opened upwards so that a stick S, which is an aerosol generating article, is inserted thereinto. The space opened upwards may be referred to as an insertion space. The insertion space may be formed by being recessed toward the inside of the body 10 by a certain depth so that at least a portion of the stick S may be inserted thereinto. The depth of the insertion space may correspond to a length of a region in the stick S, which includes an aerosol generating material and/or a medium. A lower end of the stick S may be inserted into the body 10, and an upper end of the stick S may protrude to the outside of the body 10. A user may inhale air by holding, in the mouth, the upper end of the stick S exposed to the outside.

The heater 18 may heat the stick S. The heater 18 may extend long upwards around a space into which the stick S is inserted. For example, the heater 18 may be in the form of a tube including a hollow therein. The heater 18 may be arranged around the insertion space. The heater 18 may be arranged to surround at least a portion of the insertion space. The heater 18 may heat the insertion space or the stick S inserted into the insertion space. The heater 18 may include an electrically resistive heater and/or an induction heater.

For example, the heater 18 may be a resistive heater. For example, the heater 18 may include an electrically conductive track and the heater 18 may be heated when currents flow through the electrically conductive track. The heater 18 may be electrically connected to the power source 11. The heater 18 may be provided with a current from the power source 11 and directly generate heat.

For example, the aerosol generating device 1 may include an induction coil surrounding the heater 18. The induction coil may generate heat in the heater 18. The heater 18 may be a susceptor, and the heater 18 may generate heat by a magnetic field generated by an AC current flowing through the induction coil. The magnetic field may pass through the heater 18 and generate an eddy current within the heater 18. The current may generate heat in the heater 18.

Meanwhile, a susceptor may be included inside the stick S, and the susceptor inside the stick S may generate heat by the magnetic field generated by the AC current flowing through the induction coil.

The cartridge 19 may contain an aerosol generating material in any one of a liquid state, a solid state, a gaseous state, a gel state, and the like. The aerosol generating material may include a liquid composition. For example, the liquid composition may be a liquid including a tobacco-containing material having a volatile tobacco flavor component, or a liquid including a non-tobacco material.

The cartridge 19 may be integrally formed with the body 10 or detachably coupled to the body 10.

For example, referring to FIG. 1, the cartridge 19 may be integrally formed with the body 10 and may communicate with the insertion space through an air flow channel CN.

For example, referring to FIG. 2, a space may be formed in one side of the body 10, and at least a portion of the cartridge 19 may be inserted into the space formed in one side of the body 10, so that the cartridge 19 may be mounted in the body 10. The air flow channel CN may be defined by a portion of the cartridge 19 and/or a portion of the body 10, and the cartridge 19 may communicate with the insertion space through the air flow channel CN.

The body 10 may be formed in a structure in which external air may be introduced into the body 10 while the cartridge 19 is inserted the body 10. Here, the external air introduced into the body 10 may pass through the cartridge 19 and flow into the mouth of the user.

The cartridge 19 may include a storage CO containing the aerosol generating material and/or a heater 24 heating the aerosol generating material in the storage CO. A liquid delivery element impregnated with (containing) the aerosol generating material may be arranged inside the storage CO. Here, the liquid delivery element may include a wick or the like such as a cotton fiber, a ceramic fiber, a glass fiber, or porous ceramic. An electrically conductive track of the heater 24 may be formed in a coil-shaped structure that is wound around the liquid delivery element or in a structure in contact with one side of the liquid delivery element. The heater 24 may be referred to as a cartridge heater 24.

The cartridge 19 may generate an aerosol. When the liquid delivery element is heated by the cartridge heater 24, an aerosol may be generated. The aerosol may be generated by heating the stick S by the heater 18. While the aerosol generated by the cartridge heater 24 and the heater 18 passes through the stick S, a tobacco material may be added to the aerosol, and the aerosol having the tobacco material added thereto may be inhaled into the mouth of the user through one end of the stick S.

The aerosol generating device 1 may include only the cartridge heater 24 and may not include the heater 18 in the body 10. Here, the aerosol generated by the cartridge heater 24 may have the tobacco material added thereto while passing through the stick S and may be inhaled into the mouth of the user.

The aerosol generating device 1 may include a cap (not shown). The cap may be detachably coupled to the body 10 to cover at least a portion of the cartridge 19 coupled to the body 10. The stick S may pass through the cap and be inserted into the body 10.

The power source 11 may supply power so that components of the aerosol generating device 1 operate. The power source 11 may be referred to as a battery. The power source 11 may supply power to at least one of the controller 12, the sensor 13, the cartridge heater 24, and the heater 18. When the aerosol generating device 1 includes an induction coil, the power supply 11 may supply power to the induction coil.

The controller 12 may control an overall operation of the aerosol generating device 1. The controller 12 may be mounted on a printed circuit board (PCB). The controller 12 may control an operation of at least one of the power source 11, the sensor 13, the heater 18, and the cartridge 19. The controller 12 may control operations of a display, a motor, and the like installed in the aerosol generating device 1. The controller 12 may check a state of each of the components of the aerosol generating device 1 to determine whether or not the aerosol generating device 1 is able to operate.

The controller 12 may analyze a result of detection by the sensor 13 and control processes to be performed subsequently. For example, the controller 12 may control power supplied to the cartridge heater 24 and/or the heater 18 so that the operation of the cartridge heater 24 and/or the heater 18 is initiated or terminated, on the basis of the result of the detection by the sensor 13. For example, on the basis of the result of the detection by the sensor 13, the controller 12 may control an amount of power supplied to the cartridge heater 24 and/or the heater 18 and a time for which the power is supplied to the cartridge heater 24 and/or the heater 18 so that the cartridge heater 24 and/or the heater 18 may be heated to a certain temperature or maintain an appropriate temperature.

The sensor 13 may include at least one of a temperature sensor, a puff sensor, an insertion detection sensor, a color sensor, a cartridge detection sensor, and a cap detection sensor. For example, the sensor 13 may sense at least one of a temperature of the heater 18, a temperature of the power source 11, and a temperature inside and outside the body 10. For example, the sensor 13 may sense a puff by a user. For example, the sensor 13 may sense whether or not the stick S is inserted into the insertion space. For example, the sensor 13 may sense whether or not the cartridge 19 is mounted in the body 10. For example, the sensor 13 may sense whether or not the cap is mounted on the body 10.

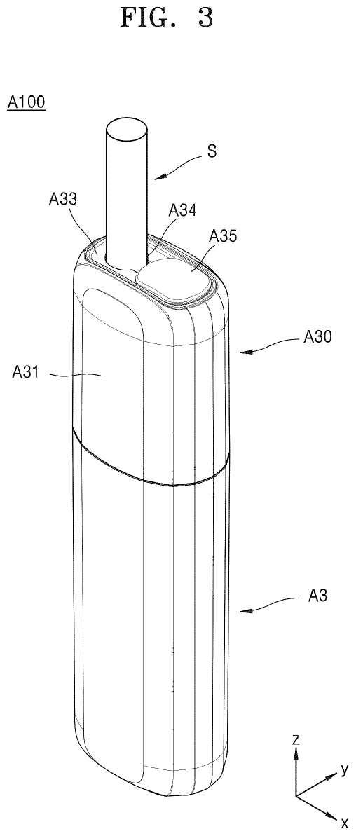

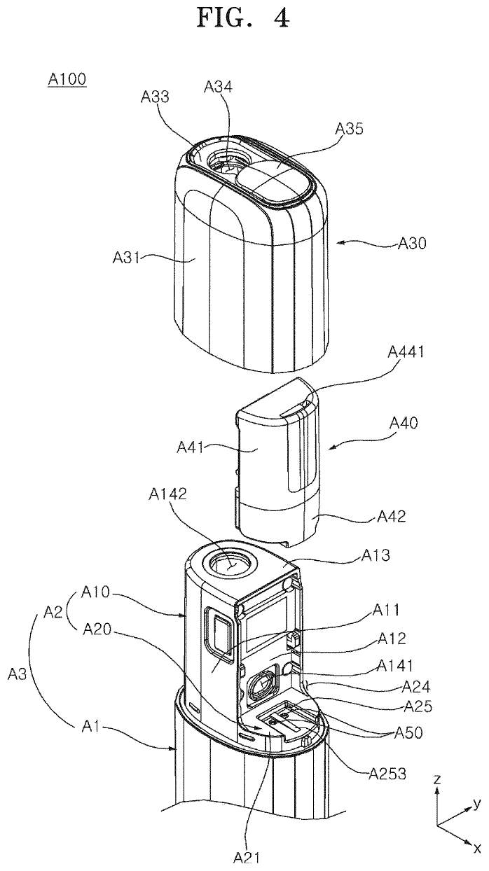

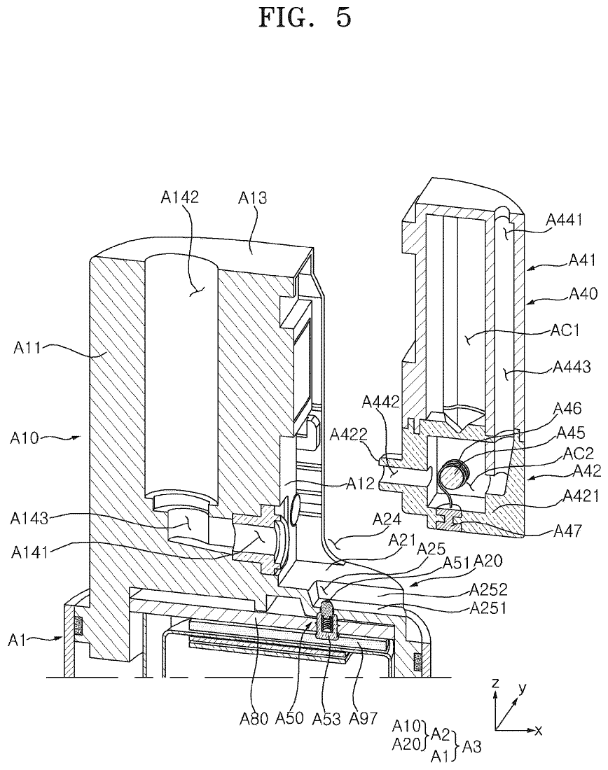

FIG. 3 is a front perspective view of an aerosol generating device according to an embodiment, FIG. 4 is a combined perspective view of a body, a cartridge, and a cap of an aerosol generating device according to an embodiment, and FIG. 5 is a cross-sectional view of an aerosol generating device according to an embodiment.

Referring to FIG. 3, an aerosol generating device A100 according to an embodiment may include a body A3. The aerosol generating device A100 may include a cap A30. The aerosol generating device A100 may include a cartridge A40. The cartridge A40 may be detachably coupled to one side of the body A3. The cap A30 may be detachably coupled to the body A3 to cover the cartridge A40. A stick S may pass through the cap A30 and be inserted into the body A3.

Referring to FIG. 4, the body A3 may include a lower body A1 and an upper body A2. Components of the aerosol generating device A100, such as a battery and a controller, may be installed inside the lower body A1. The upper body A2 may be coupled to an upper side of the lower body A1.

The upper body A2 may include a column A10 and a seating portion A20. The column A10 may extend long in a vertical direction. The column A10 may include an outer wall A11, an inner wall A12, and an upper wall A13.

The seating portion A20 may protrude from a lower portion of the inner wall A12 of the column A10. The seating portion A20 may face an upper side. A cartridge area A24 may be formed between the inner wall A12 of the column A10 and the seating portion A20. The cartridge area A24 may be located on one side of the inner wall A12 of the column A10 and may be located above the seating portion A20.

The column A10 may include an insertion space A142. The insertion space A142 may extend in the vertical direction inside the column A10 and may be opened upwards so that the upper wall A13 is opened.

A body inlet A141 may be formed in one side of the column A10. The body inlet A141 may be formed by opening the inner wall A12. The body inlet A141 may be opened to the outside of the column A10. The body inlet A141 may communicate with the insertion space A142. The body inlet A141 may be arranged to face the cartridge area A24. The body inlet A141 may communicate with the cartridge area A24.

The cartridge A40 may be detachably coupled to the upper body A2 in the cartridge area A24. The cartridge A40 may be coupled to the inner wall A12 of the column A10 and may be seated on the seating portion A20 so that a bottom thereof is supported. The cartridge A40 may include a first container A41 and a second container A42. The first container A41 may be arranged on an upper side of the second container A42. The first container A41 may store a liquid.

The cap A30 may cover the upper body A2 and may be detachably coupled to the body A3. The cap A30 may cover the upper body A2 and the cartridge A40 coupled to the upper body A2. The cap A30 may have formed therein a space into which the upper body A2 and the cartridge A40 are inserted. The space inside the cap A30 may be opened downwards. A sidewall A31 of the cap A30 may surround a side portion of the space inside the cap A30. An upper wall A33 of the cap A30 may cover an upper portion of the space inside the cap A30. An insertion hole A34 may be formed by opening the upper wall A33. When the cap A30 is coupled to the body A3, the insertion hole A34 may communicate with the insertion space A142 above the insertion space A142. A cover A35 may be movably installed on the upper wall A33. The cover A35 may slide on the upper wall A33. The cover A35 may open and close the insertion hole A34.

Referring to FIG. 5, a first chamber AC1 may be formed inside the first container A41. A liquid may be stored in the first chamber AC1. A second chamber AC2 may be formed inside the second container A42.

A cartridge inlet A441 may be formed by opening the cartridge A40. A cartridge outlet A442 may be formed by opening the cartridge A40. A cartridge flow path A443 may connect the cartridge inlet A441 to the second chamber AC2. The cartridge outlet A442 may communicate with the second chamber AC2.

The cartridge outlet A442 may be formed by opening one side of the second container A42. A discharge port A422 may surround the cartridge discharge outlet A442. The discharge port A422 may protrude from one side of the second container A42. When the cartridge A40 is coupled to the upper body A2, the discharge port A422 may be inserted into the body inlet A141, and the cartridge outlet A442 and the body inlet A141 may communicate with each other.

A wick A45 may be installed in the second chamber AC2. The wick A45 may be connected to the first chamber AC1. The wick A45 may be supplied with a liquid from the first chamber AC1. A heater A46 may generate heat and heat the wick A45. The heater A46 may be arranged in the second chamber AC2. The heater A46 may be wound around the wick A45. When the heater A46 heats the wick A45, an aerosol may be generated around the wick A45 in the second chamber AC2.

A heater terminal A47 may be exposed to a lower portion of the cartridge A40. The heater terminal A47 may be formed at a bottom of the second container A42. The heater terminal A47 may be electrically connected to the heater A46. When the cartridge A40 is coupled to the upper body A2, the heater terminal A47 may be in contact with and electrically connected to a first pin A50. Here, the heater terminal A47 may be referred to as a second pin A47.

The first pin A50 may protrude to the outside of the seating portion A20. The first pin A50 may be supplied with power from a battery installed inside the lower body A1 through a connector A97 and provide the power to the heater terminal A47 and the heater A46. The heater A46 may be supplied with power and generate heat.

Air outside the cartridge A40 may be introduced into the cartridge A40 through the cartridge inlet A441. The air may sequentially flow through the cartridge inlet A441, the cartridge flow path A443, the second chamber AC2, and the cartridge outlet A442. Air inside the cartridge A40 may be discharged to the outside of the cartridge A40 through the cartridge outlet A442. The air introduced into the cartridge A40 may be accompanied by an aerosol generated in the second chamber AC2 and discharged to the outside of the cartridge A40 through the cartridge outlet A442.

The first pin A50 may be arranged inside the body A3 and may protrude to the outside of the body A3. The body A3 may include the seating portion A20.

The seating portion A20 may have an outer recessed groove A25. The outer recessed groove A25 may be formed by recessing an upper surface A21 of the seating portion A20 downwards. The outer recessed groove A25 may be located below the cartridge area A24. The upper surface A21 of the seating portion A20 may be referred to as an outer surface of the body A3. The outer recessed groove A25 may be formed in the outer surface of the body A3.

A lower portion of the outer recessed groove A25 may be covered with a bottom portion A251, and a side portion of the outer recessed groove A25 may be covered with a circumferential portion A252. An upper side of the outer recessed groove A25 may be opened. One side portion of the outer recessed groove A25 may be opened without being covered with the circumferential portion A252. When an x direction indicated in a coordinate system is defined as the front, the front of the outer recessed groove A25 may be opened. An upper end of the first pin A50 may convexly protrude or be exposed upwards from the bottom portion A251 of the outer recessed groove A25 toward the outer recessed groove A25.

The bottom of the cartridge A40 may have a shape corresponding to the seating portion A20 and the outer recessed groove A25. When the cartridge A40 is coupled to the upper body A2, the bottom of the cartridge A40 may be seated on the seating port A20, and the first pin A50 and the second pin A47 may be electrically connected to each other.

A plurality of guide portions A253 may be provided. The guide portion A253 may extend long from the front to the rear. The guide portion A253 may be formed to be inclined and gradually become higher from the front to the rear. Each of the plurality of guide portions A253 may be arranged in front of each of a plurality of first pins A50. A height of a rear end of the guide portion A253 adjacent to the first pin A50 may be the same as or similar to a height of the first pin A50.

Accordingly, when the cartridge A40 is coupled to the upper body A2, the guide portion A253 may guide the arrangement of the cartridge A40 so that the first pin A50 and the second pin A47 contact each other.

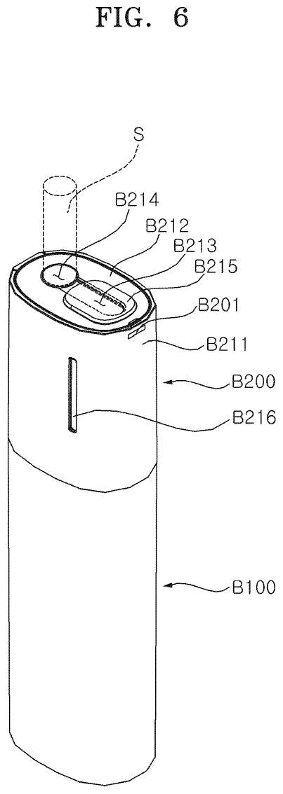

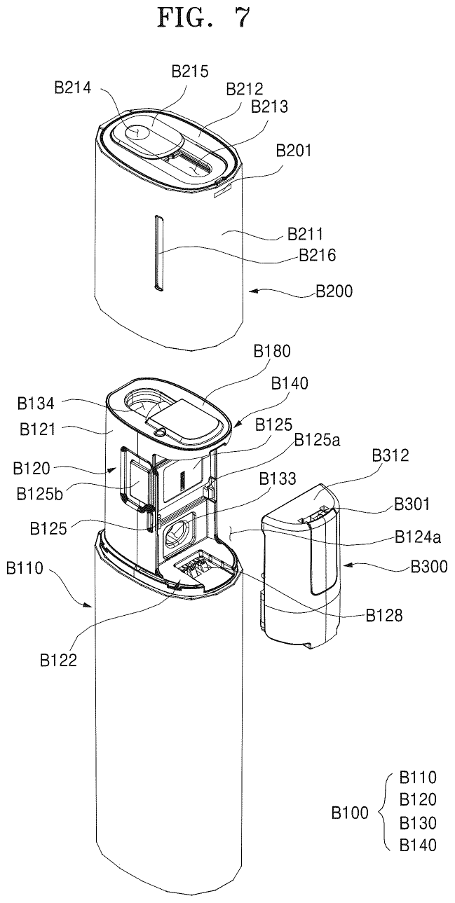

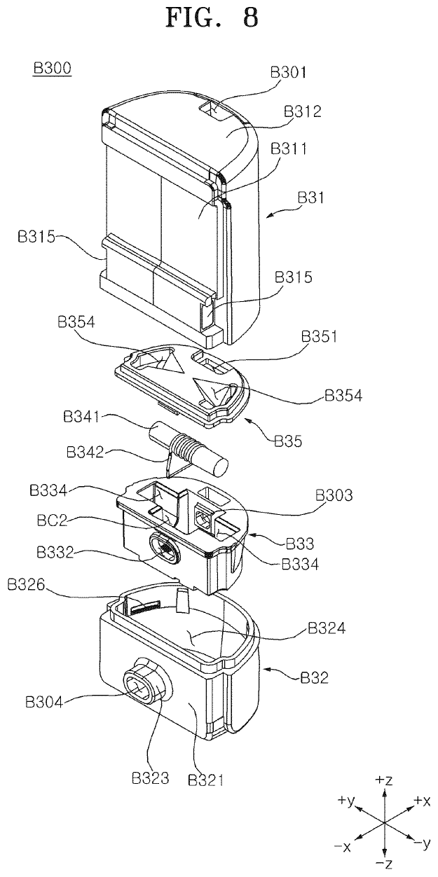

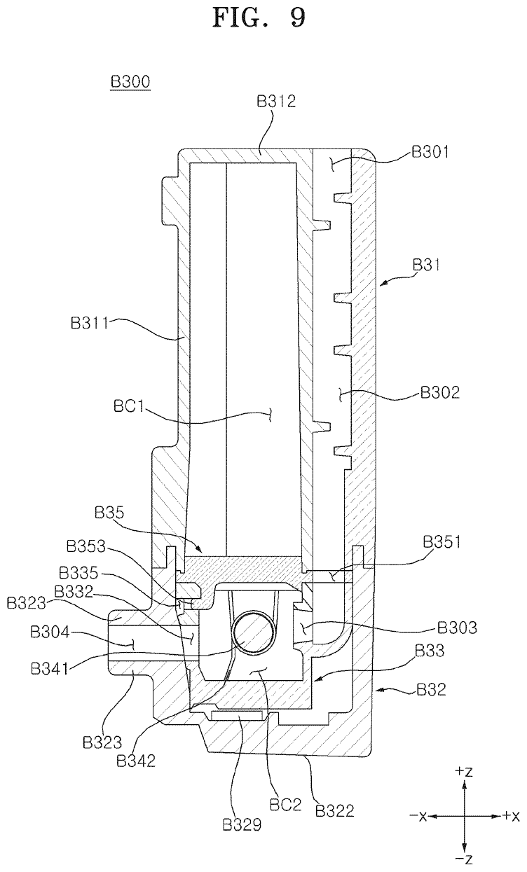

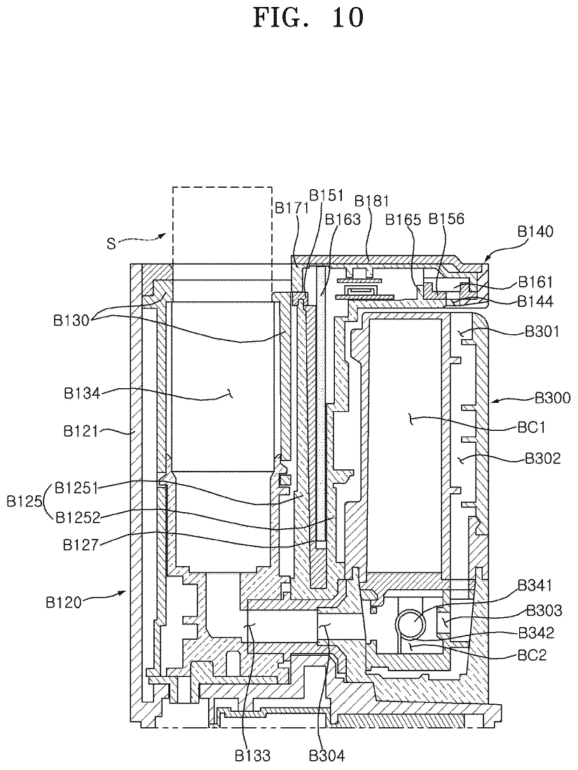

FIG. 6 is a front perspective view of an aerosol generating device according to an embodiment, FIG. 7 is a combined perspective view of a body, a cartridge, and a cap of an aerosol generating device according to an embodiment, FIG. 8 is an exploded perspective view of a cartridge of an aerosol generating device according to an embodiment, FIG. 9 is a cross-sectional view of a cartridge of an aerosol generating device according to an embodiment, and FIG. 10 is a cross-sectional view of an aerosol generating device according to an embodiment.

Referring to FIGS. 6 and 7, an aerosol generating device according to an embodiment may include a body B100 including an upper body B120 and a lower body B110. The upper body B120 may be located on an upper side of the lower body B110. The lower body B110 may extend long in a vertical direction. The body B100 may accommodate therein components for driving the aerosol generating device. The upper body B120 may provide an insertion space B134 that is opened upwards. The insertion space B134 may be located inside the upper body B120. The insertion space B134 may extend long in the vertical direction. The insertion space B134 may be formed in a pipe B130 located inside the upper body B120.

An upper case B200 may have a hollow shape with an open lower portion. The upper body B120 may be inserted into a hollow of the upper case B200. The upper case B200 may be detachably coupled to the body B100. The upper case B200 may cover the upper body B120 to surround the upper body B120. A lateral portion B211 of the upper case B200 may surround and cover a sidewall B121 of the upper body B120. An upper portion B212 of the upper case B200 may cover an upper portion B180 or an outer cover B180 of the upper body B120. When the upper case B200 is coupled to the body B100, the upper case B200 may cover the body B100 and a cartridge B300 together. The cartridge B300 may be arranged inside the upper case B200.

An insertion hole B214 may be formed by opening the upper portion B212 of the upper case B200. The insertion hole B214 may correspond to an opening of the insertion space B134. A cap B215 may be movably installed on the upper portion B212 of the upper case B200. A slide hole B213 may be formed by extending from the insertion hole B214 to one side, in the upper portion B212 of the upper case B200. The cap B215 may move along the slide hole B213. The cap B215 may open and close the insertion hole B214 and the insertion space B134. A stick S may be inserted into the insertion space B134 through the insertion hole B214. For example, the stick S may be a cigarette.

An outer wall B121 and a partition wall B125 may form a lateral portion of the upper body B120. The outer wall B121 and the partition wall B125 may be connected to each other. The outer wall B121 may be covered by an inner surface of the upper case B200. The partition wall B125 may separate a cartridge coupling space B124a from the insertion space B134.

The upper body B120 may include a seating portion B122. The seating portion B122 may extend from a lower portion of the partition wall B125 to one side. The seating portion B122 may be formed on an upper side of the lower body B110. The seating portion B122 may cover a lower portion of the cartridge coupling space B124a. A bottom surface of the cartridge B300 may be seated on and supported by the seating portion B122.

The upper body B120 may include an extension portion B140. The extension portion B140 may extend from an upper portion of the partition wall B125 to one side. The extension portion B140 may extend in a direction in which the seating portion B122 is formed. The extension portion B140 may cover an upper portion of the cartridge coupling space B124a. The extension portion B140 may cover an upper end surface of the cartridge B300. The extension portion B140 may cover a cartridge inlet B301 formed in the cartridge B300. A gap through which air may flow may be formed between the extension portion B140 and the cartridge inlet B301.

The cartridge coupling space B124a may be formed on one side of the upper body B120. The cartridge coupling space B124a may be defined by the seating portion B122 and the partition wall B125 of the upper body B120 and the extension portion B140. A bottom of the cartridge coupling space B124a may be covered by the seating portion B122. One side of the cartridge coupling space B124a may be covered by the partition wall B125 of the upper body B120. An upper side of the cartridge coupling space B124a may be covered by the extension portion B140. The cartridge coupling space B124a may be opened to the outside between the seating portion B122 and the extension portion B140.

The cartridge B300 may be inserted into the cartridge coupling space B124a to be coupled to the body B100. The cartridge B300 may be detachably coupled to the body B100. A lateral surface B311 of the cartridge B300 may face the partition wall B125. An upper end surface B312 of the cartridge B300 may be covered by the extension portion B140. A bottom surface B322 of the cartridge B300 may be seated on the seating portion B122. A cartridge terminal B128 may be connected to the cartridge B300 to supply power to a heater B342 inside the cartridge B300.

A coupling hook B125a may be formed at the upper body B120. A pusher B125b may be formed on the upper body B120. The coupling hook B125a and the pusher B125b may be formed in a pair on both sides of the upper body B120 and arranged at locations facing each other. The cartridge B300 may include a hook coupling groove B315. The hook coupling groove B315 may be formed at a location corresponding to the coupling hook B125a. When the cartridge B300 is inserted into the cartridge coupling space B124a, the coupling hook B125a may be coupled to the hook coupling groove B315 to couple the cartridge B300 to the body B100. The pusher B125b and the coupling hook B125a may move in conjunction with each other. When the pusher B125b is pressed, the coupling hook B125a may be moved in a direction detached from the hook coupling groove B315, and the cartridge B300 may be detached from the body B100.

A connection flow path B133 may be formed in a lower portion of the partition wall B125. The connection flow path B133 may communicate with the insertion space B134. The connection flow path B133 may be opened to one side of the upper body B120. When the cartridge B300 is coupled to the body B100, a discharge port B323 may be inserted into the connection flow path B133, and the connection flow path B133 and a cartridge discharge port B304 may communicate with each other.

Referring to FIG. 8, the cartridge B300 may include a first container B31 and a second container B32. The first container B31 may be coupled to an upper side of the second container B32. A plate B35 may be coupled between the first container B31 and the second container B32 or between the first container B31 and a frame B33.

The first container B31 may include a first chamber BC1 that may store a liquid therein. The first container B31 may surround the first chamber BC1, and a lower portion of the first chamber BC1 may be opened. An opening of the first chamber BC1 may be covered by the plate B35.

Referring to FIG. 9, the first container B31 may include an inflow passage B302 through which air passes. The first chamber BC1 and the inflow passage B302 may be separated from each other. The inflow passage B302 may vertically extend long in one side of the first container B31.

The first container B31 may include a cartridge inlet B301. The cartridge inlet B301 may be formed by opening an upper portion of the first container B31 and may communicate with the inflow passage B302. The cartridge inlet B301 may communicate with an upper end of the inflow passage B302. A lower end of the inflow passage B302 may communicate with a connection hole B351 and a chamber inlet B303.

The second container B32 may be coupled to a lower portion of the first container B31. The second container B32 may include a space B324 having an opened upper portion and a covered lower portion. The frame B33 may be accommodated inside the space B324 of the second container B32.

The second container B32 may include the cartridge outlet B304. The cartridge outlet B304 may be formed in a lateral portion B321 of the second container B32. The cartridge outlet B304 may be formed inside a port protruding from the lateral portion of the second container B32 in a thickness direction. The cartridge outlet B304 may communicate with the space B324. The second container B32 may include a discharge port B323. The discharge port B323 may have the cartridge outlet B304 formed therein. The discharge port B323 may protrude from the lateral portion B321 of the second container B32 to one side. The discharge port B323 may surround the cartridge outlet B304. The cartridge outlet B304 may be referred to as an outlet B304.

The frame B33 may be inserted into the space B324 inside the second container B32 to be coupled to the second container B32. A fastening element B326, which protrudes from a sidewall of the second container B32 to the space B324, may be fastened to the frame B33 to fix the frame B33.

The frame B33 may include a second chamber BC2 therein. The frame B33 may surround the second chamber BC2, and an upper portion of the second chamber BC2 may be opened. The upper portion of the second chamber BC2 may be covered by the plate B35.

The frame B33 may include the chamber inlet B303. The chamber inlet B303 may be formed by opening one surface of a sidewall surrounding the second chamber BC2. The chamber inlet B303 may be bent and extend upwards from the second chamber BC2 toward the inflow passage B302. One end of the chamber inlet B303 may communicate with the second chamber BC2, and the other end of the chamber inlet B303 may be connected to the inflow passage B302 and the connection hole B351.

The frame B33 may include a chamber outlet B332. The chamber outlet B332 may be formed in a lateral portion of the frame B33. The chamber outlet B332 may communicate with the second chamber BC2. The chamber outlet B332 may be formed inside a port protruding from the lateral portion of the frame B33 in a thickness direction. The chamber outlet B332 may communicate with the second chamber BC2. The chamber outlet B332 may be formed at a location corresponding to the cartridge outlet B304. The chamber outlet B332 may be formed at a location opposite to the chamber inlet B303 with respect to the second chamber BC2. When the frame B33 is coupled to the second container B32, the chamber outlet B332 and the cartridge outlet B304 may communicate with each other.

The frame B33 may include a wick coupling groove B334 therein. The wick coupling groove B334 may communicate with the second chamber BC2. The wick coupling groove B334 may be formed by the second chamber BC2 being depressing to one side thereof. The wick coupling grooves B334 may be formed in a pair, and the pair of wick coupling grooves B334 may be formed to be located opposite to each other in the second chamber BC2. An upper portion of the wick coupling groove B334 may be opened.

A wick B341 may have a cylindrical shape extending laterally long in the second chamber BC2. Both ends of the wick B341 may be located by being inserted into the pair of wick coupling grooves B334, respectively. A central portion of the wick B341 may be located in the second chamber BC2. The wick B341 may be connected to the first chamber BC1 to be supplied with a liquid from the first chamber BC1. The wick B341 may be fixed in the wick coupling groove B334 by the frame B33 and the plate B35.

The heater B342 may be wound around the central portion of the wick B341. The heater B342 may generate heat to heat the wick B341. For example, the heater B342 may be a resistive heater. The heater B342 may be arranged in the second chamber BC2. An end of the heater B342 may pass through a bottom of the frame B33 and be electrically connected to an electrode arranged at the bottom of the second container B32.

The plate B35 may be coupled between the first container B31 and the second container B32 or between the first container B31 and the frame B33. The plate B35 of the frame B33 may cover and seal an opened portion of the first chamber BC1. The plate B35 may cover an upper portion of the frame B33. The plate B35 may cover and seal an opened portion of the second chamber BC2.

The plate B35 may have the connection hole B351 in one side thereof. The connection hole B351 may be located between the inflow passage B302 and the chamber inlet B303. The connection hole B351 may connect the inflow passage B302 to the chamber inlet B303.

The plate B35 may include a liquid inflow hole B354. A pair of liquid inflow holes B354 may be formed at locations corresponding to the wick coupling grooves B334. The pair of liquid inflow holes B354 may be located above both ends of the wick B341. The liquid inflow hole B354 may connect the first chamber BC1 to the wick coupling groove B334. The wick B341 may be connected to the first chamber BC1 through the liquid inflow hole B354.

A hook B353 may be formed above the chamber outlet B332 at a location adjacent to the chamber outlet B332. The hook B353 may protrude downwards from one side of the plate B35. The hook B353 may be inserted into and fastened to a hook groove B335 formed in an upper portion of the frame B33. The plate B35 may be fastened to the frame B33, and the first container B31 coupled to the second container B32 may press an edge portion of the plate B35 toward the frame B33.

A user may hold, in the mouth, the stick S inserted into the insertion space B134 and inhale air. While the upper case B200 is coupled to the body B100, air may be introduced into the cartridge inlet B301 through an opening B201 formed in the upper case B200. Air may be introduced into the cartridge B300 through the cartridge inlet B301 and may be discharged to the outside of the cartridge B300 through the cartridge outlet B304. The air introduced into the cartridge B300 may be discharged to the outside by sequentially passing through the inflow passage B302, the connection hole B351, the chamber inlet B303, the second chamber BC2, the chamber outlet B332, and the cartridge outlet B304.

When the heater B342 heats the wick B341, an aerosol may be formed from the wick B341 within the second chamber BC2. Air passing through the cartridge B300 may be accompanied by an aerosol from the second chamber BC2 and discharged to the cartridge outlet B304. The air discharged through the cartridge outlet B304 may be supplied through the connection flow path B133 to the insertion space B134 and the stick S inserted into the insertion space B134.

Referring to FIG. 10, the upper body B120 may include the outer wall B121 and the partition wall B125. The outer wall B121 and the partition wall B125 may be connected to each other. The partition wall B125 may be formed by extending vertically between the pipe B130 and the cartridge coupling space B124a.

The extension portion B140 may be formed by extending from the upper portion of the upper body B120 to one side. The upper end surface B312 of the cartridge B300 may be covered by the extension portion B140. The extension portion B140 may cover the cartridge inlet B301 and the periphery thereof. A gap may be formed between the extension portion B140 and the cartridge inlet B301 and between a lower portion of the extension portion B140 and the upper end surface B312 of the cartridge B300. The gap may communicate the cartridge inlet B301 with the outside.

The pipe B130 may be formed long in a vertical direction. The pipe B130 may be formed as a hollow. The insertion space B134 may be formed inside the pipe B130. The insertion space B134 may be opened upwards. The insertion space B134 may extend vertically. The connection flow path B133 may be formed inside the pipe B130. The connection flow path B133 may be formed below the insertion space B134. One end of the connection flow path B133 may communicate with the outside of the pipe B130, and the other end of the connection flow path B133 may communicate with the insertion space B134. The connection flow path B133 may be bent to one side from a lower portion of the insertion space B134.

A first sensor B161 may be installed inside the extension portion B140. The first sensor B161 may face the upper end surface B312 of the cartridge B300 or the cartridge inlet B301. The first sensor B161 may be installed adjacent to the cartridge inlet B301. The first sensor B161 may be located above the cartridge inlet B301. The first sensor B161 may overlap the cartridge inlet B301 on the basis of the vertical direction.

The first sensor B161 may sense an ambient air flow. The first sensor B161 may be an air flow sensor or a pressure sensor. The first sensor B161 may sense a flow of air through a change in ambient air pressure. At a location adjacent to the cartridge inlet B301, the extension portion B140 may include a first sensing hole B144 for sensing an air flow. The first sensor B161 may be mounted on a substrate arranged inside the extension portion B140 and may be electrically connected to a controller (not shown). The controller may control operations of various types of components connected, on the basis that the first sensor B161 detects the flow of air.

A first sealing portion B151 may be arranged between a first partition wall portion B1251 and an inner plate B171. The first sealing portion B151 may surround and be in contact with an upper end portion of the first partition wall portion B1251. The first sealing portion B151 may be in contact with a lower end of the inner plate B171.

A sensor accommodation portion B156 of a second sealing portion may seal the periphery of a first sensing hole B144. The sensor accommodation portion B156 may be in contact with an extension plate around the first sensing hole B144. A second sensing hole formed in the sensor accommodation portion B156 may communicate with the first sensing hole B144. The sensor accommodation portion B156 may surround and be in contact with the first sensor B161.

Accordingly, a failure of a substrate or sensor may be prevented by foreign substances, aerosol discharged from around an opening of the pipe B130, or foreign substances through the first sensing hole B144.

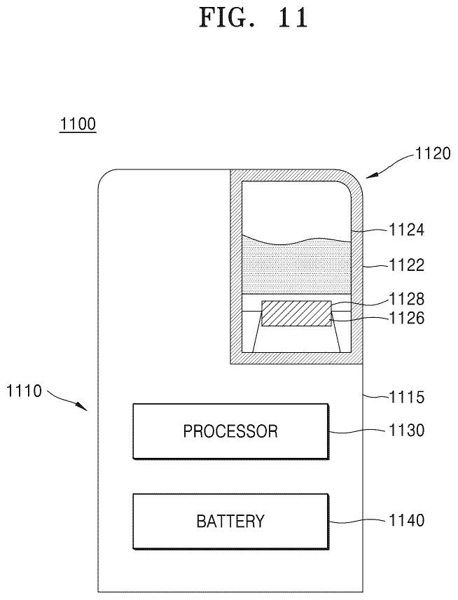

FIG. 11 is a cross-sectional view of an aerosol generating device according to an embodiment.

Referring to FIG. 11, an aerosol generating device 1100 may include a cartridge 1120 and a main body 1110 detachably coupled to the cartridge 1120. Hardware components included in the aerosol generating device 1100 are not limited to the components illustrated in FIG. 11. Those skilled in the technical field related to the present embodiment may understand that some of the hardware configurations illustrated in FIG. 11 may be omitted, or new components may be added thereto depending on designs of the aerosol generating device 1100.

Hereinafter, operations of respective components included in the aerosol generating device 1100 will be described without limiting space where the respective components are provided.

In one embodiment, the cartridge 1120 may include a housing 1122, a reservoir 1124, a heating structure 1126, and a wick 1128.

In one embodiment, the housing 1122 may form the entire appearance of the cartridge 1120, and the inside of the housing 1122 may be an internal space (or a “mounting space”) in which components of the cartridge 1120 may be placed.

In one embodiment, the reservoir 1124 may be inside the housing 1122, and an aerosol generating material may be stored in the reservoir 1124. The aerosol generating material stored in the reservoir 1124 may move in a direction toward the wick 1128 due to gravity.

In this case, the aerosol generating material may include a tobacco-containing material including a volatile tobacco flavor component or may include a liquid composition including a non-tobacco material.

According to an embodiment, the liquid composition may include any one of water, solvent, ethanol, a plant extract, fragrance, a flavoring agent, and a vitamin mixture, or may include a mixture of the components. The fragrance may include menthol, peppermint, spearmint oil, and various fruit flavor components but is not limited thereto. The flavoring agent may include components that may provide various flavors or savors to a user. The vitamin mixture may be a mixture of at least one of vitamin A, vitamin B, vitamin C, and vitamin E but is not limited thereto. The liquid composition may also include aerosol formers, such as glycerin and propylene glycol.

For example, the liquid composition may include a solution of glycerin and propylene glycol with a certain weight ratio to which nicotine salt is added. The liquid composition may also include two or more nicotine salts. The nicotine salt may be formed by adding a suitable acid, which includes an organic or inorganic acid, to nicotine. The nicotine may be naturally occurring nicotine or synthetic nicotine and may have a concentration of any suitable weight relative to the total solution weight of the liquid composition.

The acid for forming nicotine salt may be appropriately selected by considering an absorption rate of nicotine in the blood, an operation temperature of the aerosol generating device 1100, flavor or savor, solubility, and so on. For example, the acid for forming nicotine salt may be a single acid selected from a group including benzoic acid, lactic acid, salicylic acid, lauric acid, sorbic acid, levulinic acid, pyruvic acid, formic acid, acetic acid, propionic acid, butyric acid, valeric acid, caproic acid, caprylic acid, capric acid, citric acid, myristic acid, palmitic acid, stearic acid, oleic acid, linoleic acid, linolenic acid, phenylacetic acid, tartaric acid, succinic acid, fumaric acid, gluconic acid, saccharic acid, malonic acid, and malic acid or may be a mixture of two or more acids selected from the group but is not limited thereto.

In one embodiment, the wick 1128 may absorb an aerosol generating material supplied from the reservoir 1124. For example, the wick 1128 may be a cotton wick that may absorb ab aerosol generating material, but the type of wick is not limited thereto. In another example, the wick 1128 may also be a ceramic wick.

In one embodiment, the heating structure 1126 may generate an aerosol by heating the aerosol generating material absorbed in the wick 1128. For example, the heating structure 1126 may be formed in a coil shape to surround at least one region of the wick 1128 but is not limited thereto. In another example, the heating structure 1126 may be formed in a plate shape and be attached to at least one side of the wick 1128.

In one embodiment, the main body 1110 may include a main body housing 1115, a processor 1130, and a battery 1140.

In one embodiment, the main body 1115 may form the entire appearance of the main body 1110, and an internal space in which components of the main body 1110 may be arranged may be formed inside the main body 1115.

In one embodiment, the battery 1140 may supply power used for operating the aerosol generating device 1100. For example, when the cartridge 1120 is electrically connected to the main body 1110, the battery 1140 included in the main body 1110 may supply power to the heating structure 1126 within the cartridge 1120. In another example, the battery 1140 may supply power required to operate the processor 1130.

In this case, the battery 1140 may be a rechargeable battery or a disposable battery. For example, the battery 1140 may be a lithium polymer (LiPoly) battery, but the type of battery 1140 is not limited thereto.

In one embodiment, the processor 1130 may control power supply from the battery 1140 to the heating structure 1126 of the cartridge 1120.

The processor 1130 may measure the temperature of the heating structure 1126 through a separate temperature sensor (not illustrated) and control power supply to the heating structure 1126 based on the measured temperature. For example, when the temperature of the heating structure 1126 exceeds a threshold or when a temperature change amount of the heating structure 1126 exceeds a threshold change amount, the processor 1130 may stop supplying power from the battery 1140 to the heating structure 1126.

Depending on embodiments, the processor 1130 may include a plurality of processors. Also, the processor 1130 may include an array of multiple logic gates. The processor 1130 may include a combination of a general-purpose microprocessor and a memory storing a program that may be executed by the microprocessor. The processor 1130 may be configured with other types of hardware.

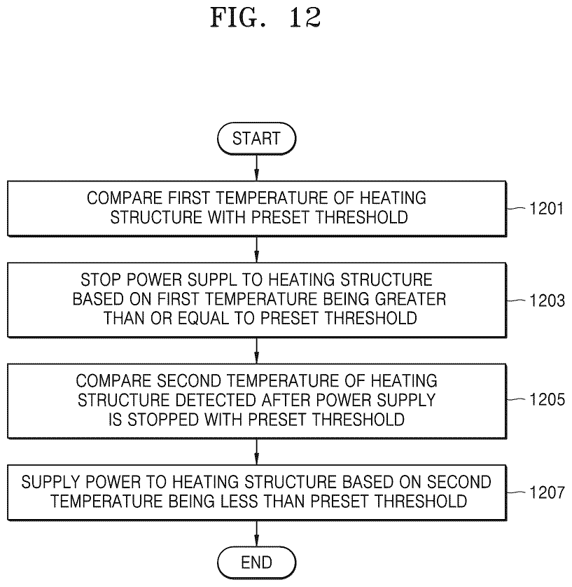

FIG. 12 is a flowchart illustrating a method of controlling power supply of an aerosol generating device, according to an embodiment. In describing FIG. 12, description corresponding to the description given above or description which is the same as or similar to the description given above may be omitted.

Referring to FIG. 12, a processor (for example, the processor 1130 of FIG. 11) of a main body (for example, the main body 1110 of FIG. 11) of an aerosol generating device may compare a first temperature of a heating structure (for example, the heating structure 1126 of FIG. 11) of a cartridge (for example, the cartridge 1120 of FIG. 11) with a preset threshold in operation 1201.

In the present disclosure, the “first temperature” of the heating structure 1126 may mean the temperature of the heating structure 1126 measured as a user's puff is detected. That is, the processor 1130 may detect overheating of the heating structure 1126 by measuring the temperature (that is, the first temperature) of the heating structure 1126 for each puff of a user.

In one embodiment, the processor 1130 may obtain the first temperature of the heating structure 1126 as a user's puff is detected and determine whether the obtained first temperature is greater than or equal to a preset threshold.

For example, when the user's puff is detected through a puff sensor (not illustrated), the processor 1130 may obtain about 250° C., which is the current temperature of the heating structure 1126, as the first temperature. Also, when the preset threshold is about 240° C., the processor 1130 may determine that the first temperature exceeds the preset threshold.

The present disclosure is not limited to comparing the first temperature of the heating structure 1126 with the preset threshold, and in another embodiment, the processor 1130 may compare a temperature change amount of the heating structure 1126 with the preset threshold change amount.

According to one embodiment, in operation 1203, the processor 1130 may stop power suppl to the heating structure 1126 based on the first temperature that is greater than or equal to the preset threshold.

In the present disclosure, the “preset threshold” may mean the smallest value of the temperature of the heating structure 1126 when an aerosol generating material in the cartridge 1120 is depleted. That is, when the temperature of the heating structure 1126 is greater than or equal to the preset threshold, the processor 1130 may determine that an aerosol generating material in the cartridge 1120 is depleted.

For example, when heating through the heating structure 1126 continues despite the aerosol generating material in the cartridge 1120 being depleted, the heating structure 1126 may heat a dry wick (for example, the wick 1128 of FIG. 11). The dry wick 1128 may refer to the wick 1128 in which no aerosol generating material is substantially present as all the aerosol generating materials impregnated in the wick 1128 are vaporized. When the dry wick 1128 is continuously heated, the heating structure 1126 may be overheated, and unintended materials (for example, a foreign material, a wick, and so on) may be heated and/or carbonized, and accordingly, an undesirable flavor of smoke may be provided to a user.

When it is determined that the aerosol generating materials in the cartridge 1120 is completely depleted, unintended heating through the heating structure 1126 of the cartridge 1120 needs to be blocked. Accordingly, when the first temperature of the heating structure 1126 is greater than or equal to the preset threshold, the processor 1130 may determine that an aerosol generating material in the cartridge 1120 is depleted and stop power supply to the heating structure 1126.

In another embodiment, when comparing a temperature change amount of the heating structure 1126 with a preset threshold change amount, the processor 1130 may stop power supply to the heating structure 1126 based on a temperature change amount that is more than or equal to the preset threshold change amount.

According to one embodiment, the processor 1130 may compare a second temperature of the heating structure 1126 of the cartridge 1120 with the preset threshold in operation 1205.

In the present disclosure, the “second temperature” of the heating structure 1126 may refer to the temperature of the heating structure 1126 measured under a preset condition after the power supply to the heating structure 1126 is stopped. That is, after the power supply to the heating structure 1126 is stopped as an aerosol generating material in the cartridge 1120 is determined to be depleted, the processor 1130 may measure the temperature (that is, the second temperature) of the heating structure 1126 under preset conditions (for example, a preset temperature measurement time, a preset number of temperature measurements, detection of a user's puff, and so on) and detect an momentary liquid shortage state of the wick 1128.

In the present disclosure, the “momentary liquid shortage state” of the wick 1128 may indicate a state in which the transfer of an aerosol generating material from the reservoir 1124 to the wick 1128 may not be smooth, and thereby, the wick 1128 does not instantaneously receive an aerosol generating material from the reservoir 1124 and is dried.

In one embodiment, the “momentary liquid shortage state” of the wick 1128 may occur because the transfer of the aerosol generating material from the reservoir 1124 to the wick 1128 is not smooth due to air bubbles generated in the process of atomizing an aerosol generating material in the reservoir 1124.

For example, the “momentary liquid shortage state” of the wick 1128 may occur when the aerosol generated through heating is not sufficiently inhaled by a user, when the amount of atomization according to an aerosol generating material is excessive, or when the cartridge is tilted by a user.

In one embodiment, the processor 1130 may obtain the second temperature of the heating structure 1126 under a preset condition after the power supply to the heating structure 1126 is stopped and may determine whether the obtained second temperature is less than the preset threshold.

For example, the processor 1130 may measure the second temperature of the heating structure 1126 for a preset period of time after the power supply to the heating structure 1126 is stopped. Also, the preset threshold value is 240° C., and among temperatures of the heating structure 1126 measured for a preset time, 230° C. which is less than the preset threshold may be obtained as the second temperature. In this case, the processor 1130 may determine that the second temperature is less than the preset threshold.

However, the conditions under which the processor 1130 measures the second temperature are not limited to a preset time. In another example, the processor 1130 may measure the second temperature of the heating structure 1126 for a preset number of times after the power supply to the heating structure 1126 is stopped. In another example, the processor 1130 may also measure the second temperature of the heating structure 1126 when a user's puff is detected after the power supply to the heating structure 1126 is stopped.

According to one embodiment, the processor 1130 may supply the power to the heating structure 1126 based on the second temperature less than the preset threshold in operation 1207. For example, the processor 1130 may supply the power corresponding to the number of remaining puffs to the heating structure 1126 based on the second temperature less than the preset threshold.

In one embodiment, even after the power supply to the heating structure 1126 is stopped, when the second temperature of the heating structure 1126 is measured to be less than the preset threshold under a preset condition, the processor 1130 may determine that an aerosol generating material in the cartridge 1120 is not depleted.

That is, when the second temperature of the heating structure 1126 is measured to be less than the preset threshold within a preset time (or a predetermined number of times) after the power supply to the heating structure 1126 is stopped, the processor 1130 may determine that the first temperature of the heating structure 1126 in operation 1203 exceeds the preset threshold due to momentary shortage of an aerosol generating material not due to depletion of the aerosol generating material in the cartridge 1120.

Accordingly, the processor 1130 may resume power supply to the heating structure 1126 of which power supply is stopped, based on the second temperature that is less than the preset threshold.

When the processor 1130 determines a “depletion state of an aerosol generating material” with only one determination, it may be difficult for the processor 1130 to distinguish whether the aerosol generating material is completely depleted or the aerosol generating material is not momentarily supplied. That is, even in a “momentary liquid shortage state” in which an aerosol generating material is not momentarily supplied, the processor 1130 may determine that the aerosol generating materials is completely depleted based on the temperature of the heating structure 1126 that is greater than or equal to the threshold and stop use of an aerosol generating device (for example, the aerosol generating device 1100 of FIG. 11). Accordingly, although appropriate smoking has to be provided in proportion to the number of remaining puffs, a user is unable to smoke in proportion to the number of remaining puffs due to the stop of use of the aerosol generating device 1100.

Therefore, in the present disclosure, the first and second determinations are made regarding whether an aerosol generating material is completely depleted or whether an aerosol generating material is not supplied momentarily, and thus, a false detection due to one-time determination of a “depletion state of an aerosol generating material” may be prevented.

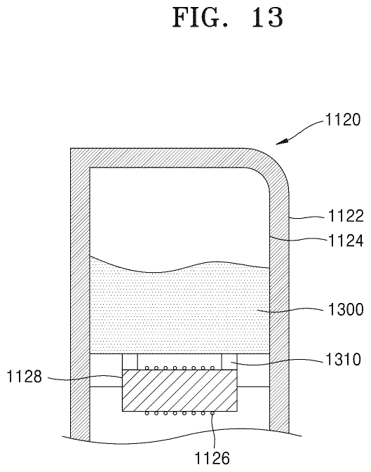

FIG. 13 is a cross-sectional view of a cartridge according to an embodiment. In describing FIG. 13, description corresponding to the description given above or description which is the same as or similar to the description given above may be omitted.

Referring to FIG. 13, a cartridge 1120 may include a housing 1122, a reservoir 1124, a heating structure 1126, and a wick 1128.

As a preset volume of an aerosol generating material 1300 is stored in the reservoir 1124, a user may smoke without separately refilling the cartridge 1120 with the aerosol generating material 1300 in each time the user smokes.

In one embodiment, the wick 1128 may receive the aerosol generating material 1300 stored in the reservoir 1124 through a liquid transfer portion 1310 and absorb the supplied aerosol generating material 1300. For example, the liquid transfer portion 1310 may be parallel to a direction of gravity such that the aerosol generating material 1300 in the reservoir 1124 moves to the wick 1128 by gravity but is not limited thereto.

The liquid transfer portion 1310 may have a hall shape. For example, a cross-section perpendicular to the direction of gravity of the liquid transfer portion 1310 may be circular, but is not limited thereto, and a shape of the liquid transfer portion 1310 may be changed in various ways according to a structure and shape of the cartridge 1120 to smoothly supply an aerosol generating material thereto.

In one embodiment, as the heating structure 1126 is heated, an aerosol generating material impregnated in the wick 1128 may be atomized, and air bubbles may be generated due to the atomized gas in the liquid transfer portion 1310.

For example, when the aerosol generated through heating is not sufficiently inhaled by a user, the gaseous aerosol may move to the liquid transfer portion 1310, and the moved gaseous aerosol may cause air bubbles to be generated in the liquid transfer portion 1310.

In another example, even when the amount of atomized aerosol moved from the wick 1128 is too much because the power higher than the set power is supplied to the heating structure 1126, the gaseous aerosol may be moved to the liquid transfer portion 1310, and air bubbles may be generated in the liquid transfer portion 1310 due to the moved gaseous aerosol.

In another example, even when the cartridge 1120 is excessively tilted or shaken by a user, air bubbles of the aerosol generating material 1300 may be generated, and some of the generated air bubbles may move into the liquid transfer portion 1310.

In one embodiment, air bubbles in the liquid transfer portion 1310 may block the aerosol generating material 1130 that is transferred from the reservoir 1124 to the wick 1128. For example, a passage in the liquid transfer portion 1310 may be partially or completely blocked by air bubbles, and the aerosol generating material 1300 that moves from the reservoir 1124 to the wick 1128 through the passage may only move to the wick 1128 through a partially or completely blocked passage.

In one embodiment, when the aerosol generating material 1300 is supplied to the wick 1128 through a partially or completely blocked passage of the liquid transfer portion 1310 during heating of the heating structure 1126, the aerosol generating material impregnated in the wick 1128 may be gradually reduced, and the wick 1128 may be in a dry state (that is, a state in which an aerosol generating material is not substantially impregnated).

Thereafter, when the air bubbles in the liquid transfer portion 1310 are removed due to an elapse of time, and when the aerosol generating material 1300 is supplied to the wick 1128 through the entire passage of the liquid transfer portion 1310, the aerosol generating material impregnated in the wick 1128 may gradually increase, and the wick 1128 may be in a hydration state (that is, a state in which an aerosol generating material is substantially impregnated therein).

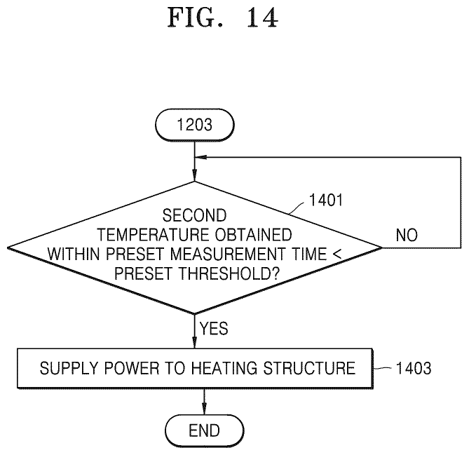

FIG. 14 is a flowchart illustrating an example in which an aerosol generating device controls power supply, according to an embodiment. FIG. 14 relates to operations after the operation 1203 of FIG. 12, and description corresponding to the description given above or description which is the same as or similar to the description given above may be omitted.

Referring to FIG. 14, a processor (for example, the processor 1130 of FIG. 11) of a main body (for example, the main body 1110 of FIG. 11) of an aerosol generating device may determine whether a second temperature of a heating structure (for example, the heating structure 1126 of FIG. 11) obtained within a preset temperature measurement time is less than a preset threshold in operation 1401.

In the present disclosure, the “preset temperature measurement time” may be set based on the time taken for the temperature of the heating structure 1126 to return to a normal temperature (that is, the temperature that is less than a preset threshold) when a wick (for example, the wick 1128 of FIG. 11) is in a momentary liquid shortage state. For example, the “preset temperature measurement time” may be an average or maximum value of a plurality of values of the time taken for the wick 1128 to return to a normal state from the momentary liquid shortage state. The “preset temperature measurement time” is not limited thereto and may be set through various experiments by a manufacturer.

For example, the preset temperature measurement time may be about 200 μs, and the processor 1130 may determine whether the temperature of the heating structure 1126 is less than a preset threshold for about 200 μs after the power supply to the heating structure 1126 is stopped.

When an aerosol generating material in a cartridge (for example, the cartridge 1120 of FIG. 11) is depleted and when the wick 1128 is in a momentary liquid shortage state, the processor 1130 may stop power supply to the heating structure 1126 in the same manner. In this case, as the power supply is stopped, the temperature of the heating structure 1126 may be gradually reduced and reach the temperature that is less than the preset threshold. However, when the wick 1128 is in a momentary liquid shortage state, an aerosol generating material is supplied from a reservoir (for example, the reservoir 1124 of FIG. 11) in a substantially quick time, and accordingly, the heat of the heating structure 1126 may be dispersed into the supplied aerosol generating material, and the temperature of the heating structure 1126 may be lowered faster than a rate at which an aerosol generating material in the cartridge 1120 is completely depleted.

That is, when an aerosol generating material in the cartridge 1120 is depleted and when the wick 1128 is in a momentary liquid shortage state, there is a difference in temperature reduction rate of the heating structure 1126, and accordingly, the processor 1130 may determine a state within the cartridge 1120 by determining whether the temperature of the heating structure 1126 is less than a preset threshold within a preset temperature measurement time. By making both the first and second determinations on a state of the cartridge 1120 during the preset temperature measurement time, a false detection due to a one-time determination of a “depletion state of an aerosol generating material” may be prevented, and a detection speed of the state of the cartridge 1120 may be reduced.

Thereafter, when the second temperature of the heating structure 1126 obtained within a preset temperature measurement time is less than a preset threshold, the processor 1130 may resume power supply to the heating structure 1126 in operation 1403.

When the temperature of the heating structure 1126 obtained within the preset temperature measurement time is greater than or equal to the preset threshold, the processor 1130 may return to operation 1203 and repeat subsequent operations.

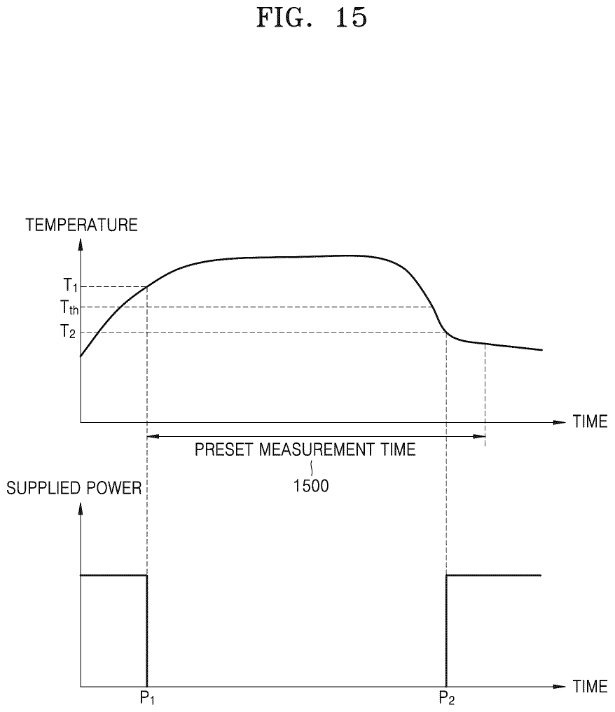

FIG. 15 is a graph illustrating a method used by an aerosol generating device to control power supply, according to a first embodiment.

Referring to FIG. 15, when the temperature of a heating structure (for example, the heating structure 1126 of FIG. 11) is measured at a point in time P1 as a user's puff is detected, a processor (for example, the processor 1130 of FIG. 11) may determine that a first temperature T1 of the heating structure 1126 exceeds a preset threshold Tin at the point in time P1. Based on the first temperature T1 exceeding the preset threshold Tₜₕ, the processor 1130 may stop power supply to the heating structure 1126.

In one embodiment, the processor 1130 may measure the temperature of the heating structure 1126 for a preset measurement time 1500 after the power supply to the heating structure 1126 is stopped. For example, the processor 1130 may periodically measure the temperature of the heating structure 1126 for the preset measurement time 1500.

In one embodiment, when the temperature of the heating structure 1126 is less than the preset threshold for the preset measurement time 1500, the processor 1130 may determine that the liquid in the wick 1128 is momentarily insufficient due to poor liquid supply liquid to a wick (for example, the wick 1128 in FIG. 11) not due to depletion of an aerosol generating material in a cartridge (for example, the cartridge 1120 in FIG. 11).

In one embodiment, when the temperature of the heating structure 1126 is measured to be less than the preset threshold Tₜₕ at a point in time P2 for the preset measurement time 1500 after power supply to the heating structure 1126 is stopped, the processor 1130 may resume power supply to the heating structure 1126 based on a second temperature T2 less than the preset threshold Tₜₕ at the point in time P2.

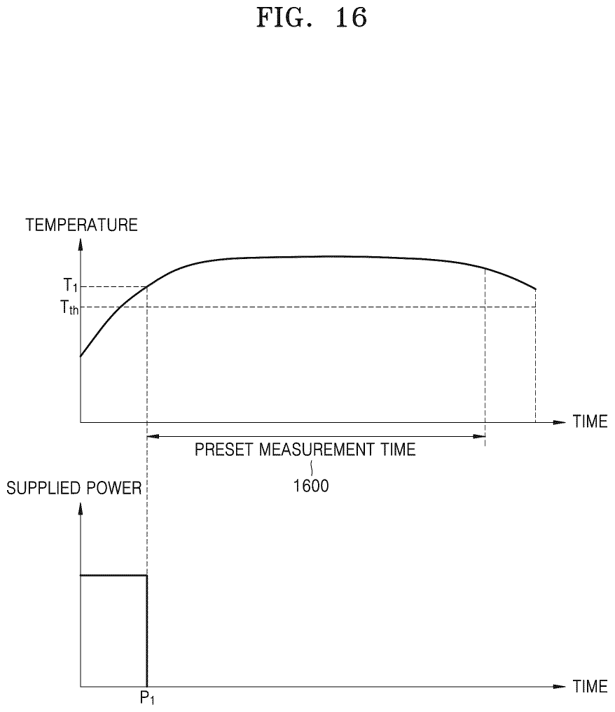

FIG. 16 is a graph illustrating a method used by an aerosol generating device to control power supply, according to a second embodiment.

Referring to FIG. 16, when the temperature of a heating structure (for example, the heating structure 1126 of FIG. 11) is measured at a point in time P1 as a user's puff is detected, a processor (for example, the processor 1130 of FIG. 11) may determine that a first temperature T1 of the heating structure 1126 exceeds a preset threshold Tₜₕ at the point in time P1. Based on the first temperature T1 exceeding the preset threshold Tₜₕ, the processor 1130 may stop power supply to the heating structure 1126.

In one embodiment, the processor 1130 may measure the temperature of the heating structure 1126 for a preset measurement time 1600 after the power supply to the heating structure 1126 is stopped. For example, the processor 1130 may periodically measure the temperature of the heating structure 1126 for the preset measurement time 1600.

In one embodiment, when the temperature of the heating structure 1126 is less than the preset threshold for the preset measurement time 1500 (that is, the temperature of the heating structure 1126 is maintained above the preset threshold Tin for the preset measurement time 1600), the processor 1130 may determine that an aerosol generating material in a cartridge (for example, the cartridge 1120 of FIG. 11) is depleted.

In one embodiment, when the temperature of the heating structure 1126 is not measured to be less than the preset threshold Tₜₕ for the preset measurement time 1600 after the power supply to the heating structure 1126 is stopped, the processor 1130 may continuously stop the power supply to the heating structure 1126.

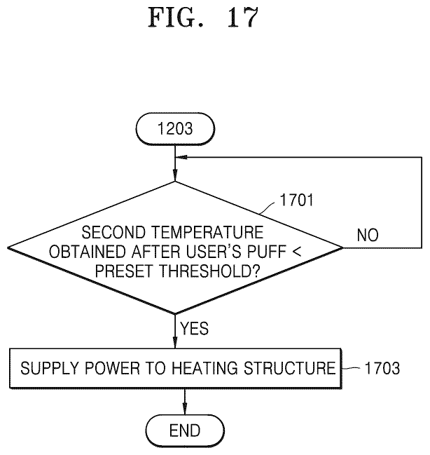

FIG. 17 is a flowchart illustrating another example in which an aerosol generating device controls power supply, according to an embodiment. FIG. 17 relates to operations after the operation 1203 of FIG. 12, and description corresponding to the description given above or description which is the same as or similar to the description given above may be omitted.

Referring to FIG. 17, a processor (for example, the processor 1130 of FIG. 11) of a main body (for example, the main body 1110 of FIG. 11) of the aerosol generating device may determine whether a second temperature of a heating structure (for example, the heating structure 1126 of FIG. 11) obtained after a user's puff is less than a preset threshold in operation 1701. In this case, the user's puff may mean a continuous puff.

For example, when a first temperature of the heating structure 1126 obtained after nth puff (for example, a third puff) of a user is greater than or equal to a preset threshold, the processor 1130 may stop the power supply to the heating structure 1126. Thereafter, the processor 1130 may determine whether a second temperature of the heating structure 1126 obtained after (n+1) th puff (for example, a fourth puff) of the user is less than the preset threshold.

That is, when the user's puff is detected after a first determination on a state of the cartridge 1120 is made, a second determination on the state of the cartridge 1120 is made, and accordingly, a false detection due to a one-time determination of a “depletion state of an aerosol generating material” may be prevented, and also, the temperature of the heating structure 1126 may be additionally detected only when a user's puff is detected, and accordingly, current consumption may be reduced.

Thereafter, when the second temperature of the heating structure 1126 obtained after the user's puff is detected is less than the preset threshold, the processor 1130 may resume power supply to the heating structure 1126 in operation 1703.

When the temperature of the heating structure 1126 obtained after the user's puff is detected is greater than or equal to the preset threshold, the processor 1130 may return to operation 1203 and repeat subsequent operations.

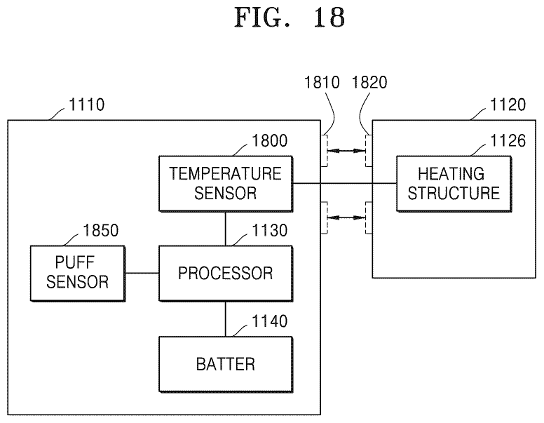

FIG. 18 is a block diagram illustrating a coupling relationship between a main body and cartridge of an aerosol generating device according to an embodiment. In describing FIG. 18, description corresponding to the description given above or description which is the same as or similar to the description given above may be omitted.

Referring to FIG. 18, an aerosol generating device (for example, the aerosol generating device 1100 of FIG. 1) may include a main body 1110 and a cartridge 1120 detachably coupled to the main body 1110. However, hardware components included in the aerosol generating device 1100 are not limited to the components illustrated in FIG. 18. Those skilled in the art may understand that some of the hardware configurations illustrated in FIG. 18 may be omitted or new configurations may be added thereto depending on designs of the aerosol generating device 1100.

In one embodiment, the main body 1110 may include a processor 1130, a battery 1140, a temperature sensor 1800, and a puff sensor 1850, and the cartridge 1120 may include a heating structure 1126.

In one embodiment, when the main body 1110 is electrically connected to and the cartridge 1120 as at least one of electrical terminals 1810 of the main body 1110 comes into contact with at least one of electrical terminals 1820 of the cartridge 1120, the temperature sensor 1800 of the main body 1110 may be electrically connected to the heating structure 1126 of the cartridge 1120.

In one embodiment, the processor 1300 may measure the temperature of the heating structure 1126 through the temperature sensor 1800. As the temperature sensor 1800 is electrically connected to the heating structure 1126, the processor 1300 may measure electrical characteristics of the heating structure 1126 through the temperature sensor 1800 and convert the measured electrical characteristics into a temperature value.

For example, the processor 1300 may measure a voltage of the temperature sensor 1800 electrically connected to the heating structure 1126, convert the measured voltage into a resistance value of the heating structure 1126 through a separate signal converter (not illustrated), and obtain the temperature of the heating structure 1126 based on the converted resistance value.

In one embodiment, the processor 1300 may measure the temperature of the heating structure 1126 through the temperature sensor 1800 based on detection of a user's puff through the puff sensor 1850. For example, the processor 1300 may measure the temperature of the heating structure 1126 through the temperature sensor 1800 whenever a user's puff is detected by the puff sensor 1850 and compare the measure temperature with a preset threshold.

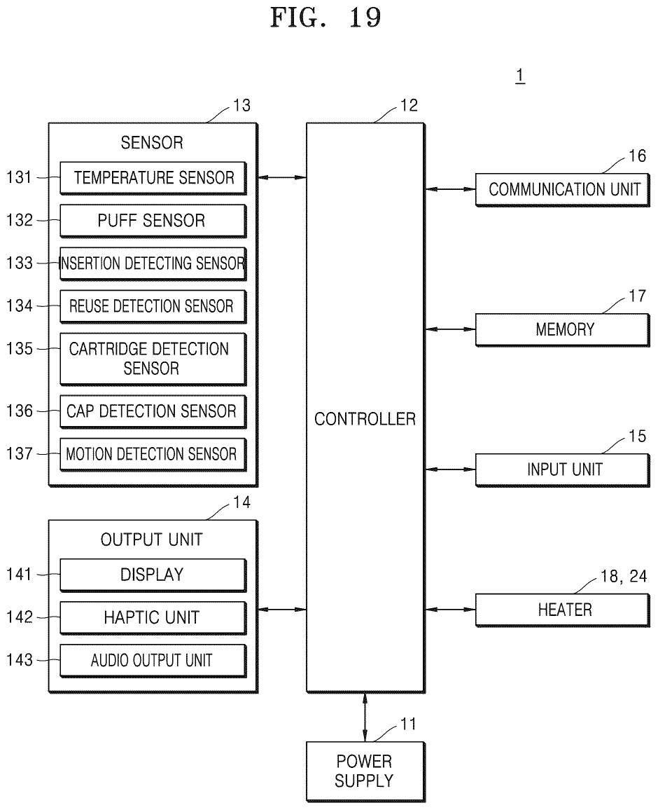

FIG. 19 is a block diagram of an aerosol generating device 1 according to an embodiment.

The aerosol generating device 1 may include a power source 11, a controller 12, a sensor 13, an output unit 14, an input unit 15, a communicator 16, a memory 17, and at least one heater 18 and 24. However, an internal structure of the aerosol generating device 1 is not limited to that illustrated in FIG. 19. In other words, according to the design of the aerosol generating device 1, one of ordinary skill in the art related to the present embodiment that some of the components shown in FIG. 19 may be omitted or new components may be added.

The sensor 13 may detect a state of the aerosol generating device 1 or a state around the aerosol generating device 1 and transmit detected information to the controller 12. On the basis of the detected information, the controller 12 may control the aerosol generating device 1 to perform various functions such as control of operations of the cartridge heater 24 and/or the heater 18, a restriction on smoking, determination of whether or not the stick S and/or the cartridge 19 are inserted, and a notification display.

The sensor 13 may include at least one of a temperature sensor 131, a puff sensor 132, an insertion detection sensor 133, a reuse detection sensor 134, a cartridge detection sensor 135, a cap detection sensor 136, and a motion detection sensor 137.

The temperature sensor 131 may detect a temperature at which the cartridge heater 24 and/or the heater 18 are heated. The aerosol generating device 1 may include a separate temperature sensor for detecting the temperatures of the cartridge heater 24 and/or the heater 18, or the cartridge heater 24 and/or the heater 18 may operate as temperature sensors.

The temperature sensor 131 may output a signal corresponding to the temperature of the cartridge heater 24 and/or the heater 18. For example, the temperature sensor 131 may include a resistor element whose resistance value changes in correspondence to a change in the temperature of the cartridge heater 24 and/or the heater 18. The temperature sensor 131 may be implemented by a thermistor or the like, which is an element using a property of changing resistance according to temperature. Here, the temperature sensor 131 may output a signal corresponding to the resistance value of the resistor element as a signal corresponding to the temperature of the cartridge heater 24 and/or the heater 18. For example, the temperature sensor 131 may include a sensor that detects a resistance value of the cartridge heater 24 and/or the heater 18. Here, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be arranged around the power source 11 to monitor a temperature of the power source 11. The temperature sensor 131 may be arranged adjacent to the power source 11. For example, the temperature sensor 131 may be attached to one surface of a battery that is the power source 11. For example, the temperature sensor 131 may be mounted on one surface of a PCB.

The temperature sensor 131 may be arranged inside the body 10 to detect an internal temperature of the body 10.

The puff sensor 132 may detect a puff by a user on the basis of various physical changes in an air flow path. The puff sensor 132 may output a signal corresponding to the puff. For example, the puff sensor 132 may be a pressure sensor. The puff sensor 132 may output a signal corresponding to internal pressure of the aerosol generating device 1. Here, the internal pressure of the aerosol generating device 1 may correspond to pressure of the air flow path through which a gas flows. The puff sensor 132 may be arranged in correspondence to the air flow path through which the gas flows in the aerosol generating device 1.

The insertion detection sensor 133 may detect insertion and/or removal of the stick S. The insertion detection sensor 133 may detect a signal change due to the insertion and/or removal of the stick S. The insertion detection sensor 133 may be installed around an insertion space. The insertion detection sensor 133 may detect the insertion and/or removal of the stick S according to a change in a dielectric constant inside the insertion space. For example, the insertion detection sensor 133 may be an inductive sensor and/or a capacitance sensor.

The inductive sensor may include at least one coil. The coil of the inductive sensor may be arranged adjacent to the insertion space. For example, when a magnetic field changes around the coil through which a current flows, characteristics of the current flowing through the coil may change according to Faraday's law of electromagnetic induction. Here, the characteristics of the current flowing through the coil may include a frequency of an alternating current, a current value, a voltage value, an inductance value, an impedance value, and the like.

The inductive sensor may output a signal corresponding to the characteristics of the current flowing through the coil. For example, the inductive sensor may output a signal corresponding to an inductance value of the coil.

The capacitance sensor may include a conductor. The conductor of the capacitance sensor may be arranged adjacent to the insertion space. The capacitance sensor may output a signal corresponding to an ambient electromagnetic characteristic, e.g., a capacitance around the conductor. For example, when the stick S including a metal wrapper is inserted into the insertion space, the electromagnetic characteristic around the conductor may be changed by the wrapper of the stick S.

The reuse detection sensor 134 may detect whether or not the stick S is reused. The reuse detection sensor 134 may be a color sensor. The color sensor may detect a color of the stick S. The color sensor may detect a color of a portion of the wrapper wrapping the outside of the stick S. The color sensor may detect a value for an optical characteristic corresponding to a color of an object, on the basis of light reflected from the object. For example, the optical characteristic may be a wavelength of light. The color sensor may be implemented as a single component with a proximity sensor or may be implemented as a separate component distinguished from the proximity sensor.

At least a portion of the wrapper constituting the stick S may have a color changing by an aerosol. When the stick S is inserted into the insertion space, the reuse detection sensor 134 may be arranged in correspondence to a location at which at least the portion of the wrapper whose color changes by the aerosol is arranged. For example, before the stick S is used by the user, the color of at least the portion of the wrapper may be a first color. Here, when at least the portion of the wrapper is wetted by the aerosol while the aerosol generated by the aerosol generating device 1 passes through the stick S, the color of at least the portion of the wrapper may be changed to a second color. The color of at least the portion of the wrapper may be maintained in the second color after changing from the first color to the second color.

The cartridge detection sensor 135 may detect mounting and/or removal of the cartridge 19. The cartridge detection sensor 135 may be implemented by an inductance-based sensor, a capacitive sensor, a resistance sensor, a hall sensor (a hall IC) using a hall effect, or the like.

The cap detection sensor 136 may detect mounting and/or removal of a cap. When the cap is detached from the body 10, a portion of the cartridge 19 and the body 10 covered by the cap may be exposed to the outside. The cap detection sensor 136 may be implemented by a contact sensor, a hall sensor (a hall IC), an optical sensor, or the like.

The motion detection sensor 137 may detect a motion of the aerosol generating device 1. The motion detection sensor 137 may be implemented as at least one of an acceleration sensor and a gyro sensor.

In addition to the sensors 131 to 137 described above, the sensor 13 may further include at least one of a humidity sensor, an atmospheric pressure sensor, a magnetic sensor, a position sensor (e.g., a global positioning system (GPS)), and a proximity sensor. Functions of the respective sensors may be intuitively inferred from names thereof by one of ordinary skill in the art, and thus, detailed descriptions thereof may be omitted.

The output unit 14 may output information regarding the state of the aerosol generating device 1 and provide the information to the user. The output unit 14 may include at least one of a display 141, a haptic unit 142, and a sound output unit 143, but is not limited thereto. When the display 141 and a touch pad form a layer structure to form a touch screen, the display 141 may be used as an input device in addition to an output device.

The display 141 may visually provide the user with information regarding the aerosol generating device 1. For example, the information regarding the aerosol generating device 1 may refer to various types of information such as a charging/discharging state of the power source 11 of the aerosol-generating device 1, a preheating state of the heater 18, the insertion/removal state of the stick S and/or the cartridge 19, the mounting/removal state of the cap, and the restriction on use of the aerosol generating device 1 (e.g., detection of an abnormal article), and the display 141 may output the information to the outside. For example, the display 141 may be in the form of a light emitting diode (LED) light emitting device. For example, the display 141 may be a liquid crystal display (LCD) panel, an organic light emitting display (OLED) panel, or the like.

The haptic unit 142 may tactilely provide the user with the information regarding the aerosol generating device 1 by converting an electrical signal into a mechanical stimulus or an electrical stimulus. For example, when initial power is supplied to the cartridge heater 24 and/or the heater 18 for a set time, the haptic unit 142 may generate vibration corresponding to completion of initial preheating. The haptic unit 142 may include a vibration motor, a piezoelectric element, or an electrical stimulation device.

The sound output unit 143 may audibly provide the user with the information regarding the aerosol generating device 1. For example, the sound output unit 143 may convert the electrical signal into a sound signal and output the sound signal to the outside.

The power supply 11 may supply power used to operate the aerosol generating device 1. The power source 11 may supply power so that the cartridge heater 24 and/or the heater 18 may be heated. In addition, the power source 11 may supply power needed for operations of the sensor 13, the output unit 14, the input unit 15, the communicator 16, and the memory 17, which are other components provided within the aerosol generating device 1. The power source 11 may be a rechargeable battery or a disposable battery. For example, the power supply 11 may be a lithium polymer (LiPoly) battery, but is not limited thereto.

Although not shown in FIG. 19, the aerosol generating device 1 may further include a power protection circuit. The power protection circuit may be electrically connected to the power source 11 and may include a switching element.

The power protection circuit may cut off an electrical path for the power source 11 according to a certain condition. For example, the power protection circuit may cut off the electrical path for the power source 11 when a voltage level of the power source 11 is a first voltage or more corresponding to overcharging. For example, the power protection circuit may cut off the electrical path for the power source 11 when the voltage level of the power source 11 is less than a second voltage corresponding to overdischarge.

The heater 18 may be supplied with power from the power source 11 and heat a medium or an aerosol generating material within the stick S. Although not shown in FIG. 19, the aerosol generating device 1 may further include a power conversion circuit (e.g., a DC/DC converter) that converts power of the power source 11 and supplies the converted power to the cartridge heater 24 and/or the heater 18. In addition, when the aerosol generating device 1 generates an aerosol by an induction heating method, the aerosol generating device 1 may further include a DC/AC converter that converts DC power of the power source 11 into AC power.

The controller 12, the sensor 13, the output unit 14, the input unit 15, the communicator 16, and the memory 17 may be supplied with power from the power source 11 to perform functions. Although not shown in FIG. 19, the aerosol generating device 1 may further include a power conversion circuit that converts power of the power source 11 and supplies the power to each of components, e.g., a low-dropout (LDO) circuit or a voltage regulator circuit. Also, although not shown in FIG. 19, a noise filter may be provided between the power source 11 and the heater 18. The noise filter may be a low pass filter. The low pass filter may include at least one inductor and a capacitor. A cutoff frequency of the low pass filter may correspond to a frequency of a high-frequency switching current applied from the power source 11 to the heater 18. The low pass filter may prevent a high-frequency noise component from being applied to the sensor 13, such as the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater 18 may be implemented by a metal wire, a metal plate on which an electrically conductive track is arranged, or a ceramic heating element, but is not limited thereto.

In an embodiment, the heater 18 may include an induction heater. For example, the heater 18 may include a susceptor that generates heat through a magnetic field applied by a coil to heat an aerosol generating material.

The input unit 15 may receive information input from the user or output the information to the user. For example, the input unit 15 may be a touch panel. The touch panel may include at least one touch sensor for detecting a touch. For example, the touch sensor may include a capacitive touch sensor, a resistive touch sensor, a surface acoustic touch sensor, an infrared touch sensor, or the like, but is not limited thereto.

The display 141 and the touch panel may be implemented as one panel. For example, the touch panel may be inserted into the display 141 (e.g., may be a on-cell type or in-cell type). For example, the touch panel may be added on the display 141 (e.g., may be an add-on type).

Meanwhile, the input unit 15 may include a button, a keypad, a dome switch, a jog wheel, a jog switch, or the like, but is not limited thereto.

The memory 17 may be hardware for storing various types of data processed within the aerosol generating device 1 and may store pieces of data processed by the controller 12 and pieces of data to be processed by the controller 12. The memory 17 may include at least one type of storage medium from among a flash memory type, a hard disk type, a multimedia card micro type, a card type memory (e.g., a SD or XD memory or the like), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 17 may store data or the like regarding an operation time of the aerosol generating device 1, the maximum number of puffs, the current number of puffs, at least one temperature profile, and a smoking pattern of the user.

The communicator 16 may include at least one component for communication with another electronic device. For example, the communicator 16 may include at least one of a short-range wireless communication unit and a wireless communication unit.

The short-range wireless communication unit may include a Bluetooth communication unit, a Bluetooth low energy (BLE) communication unit, a near field communication unit, a wireless local area network ((WLAN) (Wi-Fi)) communication unit, a Zigbee communication unit, an infrared data association (IrDA) communication unit, a Wi-Fi Direct (WFD) communication unit, an ultra wideband (UWB) communication unit, an Ant+ communication unit, and the like, but is not limited thereto.

The wireless communication unit may include a cellular network communication unit, an Internet communication unit, a computer network (e.g., LAN or WAN) communication unit, and the like, but is not limited thereto.

Although not shown in FIG. 19, the aerosol generating device 1 may further include a connection interface such as a universal serial bus (USB) interface, and may connect with another external device through the connection interface such as a USB interface to transmit and receive information or charge the power 11.

The controller 12 may control an overall operation of the aerosol generating device 1. In an embodiment, the controller 12 may include at least one processor. The processor may be implemented as an array of a plurality of logic gates or may be implemented as a combination of a general-purpose microprocessor and a memory that stores a program executable by the microprocessor. In addition, one of ordinary skill in the art to which the present embodiment pertains may understand that the processor may be implemented as other types of hardware.

The controller 12 may control the temperature of the heater 18 by controlling supply power from the power source 11 to the heater 18. The controller 12 may control the temperature of the cartridge heater 24 and/or the heater 18 on the basis of the temperature of the cartridge heater 24 and/or the heater 18 sensed by the temperature sensor 131. The controller 12 may adjust power supplied to the cartridge heater 24 and/or the heater 18, on the basis of the temperature of the cartridge heater 24 and/or the heater 18. For example, the controller 12 may determine a target temperature for the cartridge heater 24 and/or the heater 18, on the basis of a temperature profile stored in the memory 17.

The aerosol generating device 1 may include a power supply circuit (not shown) electrically connected to the power source 11 between the power source 11 and the cartridge heater 24 and/or the heater 18. The power supply circuit may be electrically connected to the cartridge heater 24, the heater 18, or an induction coil. The power supply circuit may include at least one switching element. The switching element may be implemented by a bipolar junction transistor (BJT), a field effective transistor (FET), or the like. The controller 12 may control the power supply circuit.

The controller 12 may control power supply by controlling switching of the switching element of the power supply circuit. The power supply circuit may be an inverter that converts DC power output from the power source 11 into AC power. For example, the inverter may include a full-bridge circuit or a half-bridge circuit including a plurality of switching elements.

The controller 12 may turn on the switching element so that power is supplied from the power source 11 to the cartridge heater 24 and/or the heater 18. The controller 12 may turn off the switching element to cut off the supply of power to the cartridge heater 24 and/or the heater 18. The controller 12 may adjust a current supplied from the power source 11 by adjusting a frequency and/or duty ratio of a current pulse input into the switching element.

The controller 12 may control a voltage output from the power source 11 by controlling switching of the switching element of the power supply circuit. The power conversion circuit may convert the voltage output from the power source 11. For example, the power conversion circuit may include a buck-converter that steps down the voltage output from the power source 11. For example, the power conversion circuit may be implemented through a buck-boost converter, a zener diode, or the like.

The controller 12 may adjust a level of the voltage output from the power conversion circuit by controlling an on/off operation of the switching element included in the power conversion circuit. When the switching element continues to be turned on, the level of the voltage output from the power conversion circuit may correspond to a level of a voltage output from the power source 11. The duty ratio for the on/off operation of the switching element may correspond to a ratio of the voltage output from the power conversion circuit to the voltage output from the power source 11. The level of the voltage output from the power conversion circuit may decrease with a decrease in the duty ratio for the on/off operation of the switching element. The heater 18 may be heated on the basis of the voltage output from the power conversion circuit.

The controller 12 may control power to be supplied to the heater 18 by using at least one of a pulse width modulation (PWM) method and a proportional-integral-differential (PID) method.

For example, the controller 12 may control a current pulse having a certain frequency and duty ratio to be supplied to the heater 18 by using the PWM method. The controller 12 may control the power supplied to the heater 18 by adjusting the frequency and duty ratio of the current pulse.

For example, the controller 12 may determine a target temperature to be controlled, on the basis of the temperature profile. The controller 12 may control the power supplied to the heater 18 by using the PID method, which is a feedback control method through a difference value between the temperature of the heater 18 and the target temperature, a value obtained by integrating the difference value over time, and a value obtained by differentiating the difference value over time.

The controller 12 may prevent the cartridge heater 24 and/or the heater 18 from overheating. For example, on the basis that the temperature of the cartridge heater 24 and/or the heater 18 exceeds a preset limit temperature, the controller 12 may control an operation of the power conversion circuit so that the supply of power to the cartridge heater 24 and/or the heater 18 stops. For example, on the basis that the temperature of the cartridge heater 24 and/or the heater 18 exceeds the preset limit temperature, the controller 12 may reduce an amount of power supplied to the cartridge heater 24 and/or the heater 18 by a certain ratio. For example, on the basis that the temperature of the cartridge heater 24 exceeds the preset limit temperature, the controller 12 may determine that the aerosol generating material accommodated in the cartridge 19 is exhausted and cut off the power supply to the cartridge heater 24.

The controller 12 may control charging and discharging of the power source 11. The controller 12 may identify the temperature of the power source 11 on the basis of an output signal of the temperature sensor 131.

When a power line is connected to a battery terminal of the aerosol generating device 1, the controller 12 may identify whether or not the temperature of the power source 11 is a first limit temperature or more which is a reference for blocking charging of the power source 11. When the temperature of the power source 11 is less than the first limit temperature, the controller 12 may control the power source 11 to be charged, on the basis of a preset charging current. The controller 12 may block charging of the power source 11 when the temperature of the power source 11 is the first limit temperature or more.

While the power of the aerosol generating device 1 is turned on, the controller 12 may identify whether or not the temperature of the power source 11 is a second limit temperature or more which is a reference for blocking discharge of the power source 11. The controller 12 may control power stored in the power source 11 to be used when the temperature of the power source 11 is less than the second limit temperature. When the temperature of the power source 11 is the second limit temperature or more, the controller 12 may stop using the power stored in the power source 11.

The controller 12 may calculate a remaining capacity of the power stored in the power source 11. For example, the controller 12 may calculate the remaining capacity of the power source 11 on the basis of a voltage and/or current sensing value of the power source 11.

The controller 12 may determine, through the insertion detection sensor 133, whether or not the stick S is inserted into the insertion space. The controller 12 may determine that the stick S is inserted, on the basis of the output signal of the insertion detection sensor 133. When determining that the stick S is inserted into the insertion space, the controller 12 may control power to be supplied to the cartridge heater 24 and/or the heater 18. For example, the controller 12 may supply power to the cartridge heater 24 and/or the heater 18, on the basis of the temperature profile stored in the memory 17.

The controller 12 may determine whether or not the stick S is removed from the insertion space. For example, the controller 12 may determine, through the insertion detection sensor 133, whether or not the stick S is removed from the insertion space. For example, when the temperature of the heater 18 is the preset limit temperature or more or when a temperature change gradient of the heater 18 is a set gradient, the controller 12 may determine that the stick S is removed from the insertion space. When determining that the stick S is removed from the insertion space, the controller 12 may cut off the supply of power to the cartridge heater 24 and/or the heater 18.

The controller 12 may control a power supply time and/or a power supply amount with respect to the heater 18, according to a state of the stick S detected by the sensor 13. The controller 12 may identify, on the basis of a look-up table, a level range including a level of a signal of the capacitance sensor. The controller 12 may determine an amount of moisture in the stick S, according to the identified level range.

When the stick S is over-humidified, the controller 12 may increase a preheating time of the stick S compared to a normal state by controlling the power supply time with respect to the heater 18.

The controller 12 may determine, through the reuse detection sensor 134, whether or not the stick S inserted into the insertion space is reused. For example, the controller 12 may compare a sensing value of a signal of the reuse detection sensor 134 with a first reference range including a first color and when the sensing value is included in the first reference range, determine that the stick S is not used. For example, the controller 12 may compare the sensing value of the signal of the reuse detection sensor 134 with a second reference range including a second color and when the sensing value is included in the second reference range, determine that the stick S is used. When determining that the stick S is used, the controller 12 may cut off the supply of power to the cartridge heater 24 and/or the heater 18.

The controller 12 may determine, through the cartridge detection sensor 135, whether or not the cartridge 19 is coupled and/or removed. For example, the controller 12 may determine whether or not the cartridge 19 is coupled or removed, on the basis of a sensing value of the signal of the cartridge detection sensor 135.

The controller 12 may determine whether or not the aerosol generating material of the cartridge 19 is exhausted. For example, the controller 12 may apply power to preheat the cartridge heater 24 and/or the heater 18, determine whether or not the temperature of the cartridge heater 24 exceeds the limit temperature in a preheating period, and when the temperature of the cartridge heater 24 exceeds the limit temperature, determine that the aerosol generating material of the cartridge 19 is exhausted. When determining that the aerosol generating material of the cartridge 19 is exhausted, the controller 12 may cut off the supply of power to the cartridge heater 24 and/or the heater 18.

The controller 12 may determine whether or not the cartridge 19 may be used. When the current number of puffs is greater than or equal to the maximum number of puffs set in the cartridge 19, the controller 12 may determine, on the basis of data stored in the memory 17, that the cartridge 19 may not be used. For example, when the total time for which the heater 24 is heated is a preset maximum time or more or the total amount of power supplied to the heater 24 is a preset maximum amount of power or more, the controller 12 may determine that the cartridge 19 may not be used.

The controller 12 may determine inhalation by the user through the puff sensor 132. For example, the controller 12 may determine whether or not a puff occurs, on the basis of a sensing value of a signal of the puff sensor 132. For example, the controller 12 may determine an intensity of the puff, on the basis of the sensing value of the signal of the puff sensor 132. When the number of puffs reaches the preset maximum number of puffs or when puffs are not detected for a preset time or more, the controller 12 may cut off the supply of power to the cartridge heater 24 and/or the heater 18.

The controller 12 may determine, through the cap detection sensor 136, whether a cap is coupled and/or removed. For example, the controller 12 may determine whether or not the cap is coupled and/or removed, on the basis of a sensing value of a signal of the cap detection sensor 136.

The controller 12 may control the output unit 14 on the basis of the result of detection by the sensor 13. For example, when the number of puffs counted through the puff sensor 132 reaches a preset number, the controller 12 may notify the user that the aerosol generating device 1 is soon terminated, through at least one of the display 141, the haptic unit 142, and the sound output unit 143. For example, the controller 12 may notify the user through the output unit 14 that the aerosol generating device 1 is soon terminated, on the basis of the determination that the stick S is not present in the insertion space. For example, the controller 12 may notify the user through the output unit 14 that the aerosol generating device 1 is soon terminated, on the basis of the determination that the cartridge 19 and/or the cap are not mounted. For example, the controller 12 may transmit information regarding the temperature of the cartridge heater 24 and/or the heater 18 to the user through the output unit 14.

The controller 12 may store and update, in the memory 17, a history of a certain event that occurs, on the basis of the occurrence of the event. The event may include detection of insertion of the stick S, initiation of heating of the stick S, detection of puffs, termination of the puffs, detection of overheating of the cartridge heater 24 and/or the heater 18, detection of application of an overvoltage to the cartridge heater 24 and/or the heater 18, termination of heating of the stick S, an operation such as power on/off of the aerosol generating device 1, initiation of charging of the power source 11, detection of overcharging of the power source 11, termination of charging of the power source 11, and the like. The history of the event may include a date and time when the event occurs, log data corresponding to the event, and the like. For example, when the certain event is the detection of insertion of the stick S, the log data corresponding to the event may include data regarding the sensing value of the insertion detection sensor 133 and the like. For example, when the certain event is the detection of overheating of the cartridge heater 24 and/or the heater 18, the log data corresponding to the event may include data regarding the temperature of the cartridge heater 24 and/or the heater 18, the voltage applied to the cartridge heater 24 and/or the heater 18, a current flowing through the cartridge heater 24 and/or the heater 18, and the like.

The controller 12 may control to form a communication link with an external device such as a mobile terminal of the user. When data regarding authentication is received from the external device through the communication link, the controller 12 may release a restriction on use of at least one function of the aerosol generating device 1. Here, the data regarding the authentication may include data indicating completion of user authentication for the user corresponding to the external device. The user may perform the user authentication through the external device. The external device may determine whether or not user data is valid, on the basis of the birthday of the user, a unique number indicating the user, and the like and receive, from an external server, data regarding use authority over the aerosol generating device 1. The external device may transmit the data indicating the completion of the user authentication to the aerosol generating device 1, on the basis of the data regarding the use authority. When the user authentication is completed, the controller 12 may release the restriction on the use of at least one function of the aerosol generating device 1. For example, when the user authentication is completed, the controller 12 may release a restriction on use of a heating function of supplying power to the heater 18.

The controller 12 may transmit data regarding the state of the aerosol generating device 1 to the external device through the communication link formed with the external device. On the basis of the received data regarding the state of the aerosol generating device 1, the external device may output the remaining capacity of the power source 11 of the aerosol generating device 1, an operation mode, and the like through a display of the external device.

The external device may transmit a location search request to the aerosol generating device 1, on the basis of an input for initiating a location search of the aerosol generating device 1. When receiving the location search request from the external device, the controller 12 may control at least one of output devices to perform an operation corresponding to the location search, on the basis of the received location search request. For example, the haptic unit 142 may generate vibration in response to the location search request. For example, the display 141 may output an object corresponding to the location search and an end of the search in response to the location search request.

When receiving firmware data from the external device, the controller 12 may control to perform a firmware update. The external device may identify a current version of firmware of the aerosol generating device 1 and determine whether or not a new version of the firmware is present. When an input for requesting firmware download is received, the external device may receive a new version of firmware data and transmit the new version of firmware data to the aerosol generating device 1. When receiving the new version of firmware data, the controller 12 may control the firmware update of the aerosol generating device 1 to be performed.

The controller 12 may transmit data regarding a sensing value of at least one sensor 13 to the external server (not shown) through the communicator 16, and receive from the server and store a learning model generated by learning the sensing value through machine learning such as deep learning. The controller 12 may perform an operation of determining an inhalation pattern of the user, an operation of generating a temperature profile, and the like by using the learning model received from the server. The controller 12 may store, in the memory 17, sensing value data of at least one sensor 13, data for training an artificial neural network (ANN), and the like. For example, the memory 17 may store a database for each component provided in the aerosol generating device 1, which is for training the ANN, and weights and biases constituting the structure of the ANN. The controller 12 may generate at least one learning model used for determining the inhalation pattern of the user, generating the temperature profile, and the like, by learning data regarding the sensing value of the at least one sensor 13, the inhalation pattern of the user, the temperature profile, and the like which are stored in the memory 17.

Some embodiments or other embodiments of the disclosure described above are not exclusive or distinct from each other. In some embodiments or other embodiments of the disclosure described above, respective components or functions may be used in combination with one another or combined with one another.

For example, a component A described in a particular embodiment and/or drawing and a component B described in another embodiment and/or drawing may be combined with each other. In other words, even when coupling between components is not directly described, the coupling may be made except when the coupling is described as impossible.

The above description should not be construed as being limited in all respects but should be considered illustrative. The scope of the disclosure should be determined by the logical interpretation of appended claims, and all changes within the equivalent scope of the disclosure are included in the scope of the disclosure.

According to various embodiments, a false detection of a depletion state of an aerosol generating material may be prevented.

In addition, the accuracy of determination on an internal state of a cartridge may be increased by determining multiple times based on the temperature of a heater whether an aerosol generating material is completely depleted or the aerosol generating material is not momentarily supplied.

Also, because forced stopping of smoking due to false detection may be prevented, a user's smoking satisfaction may be increased.

However, effects of the embodiments are not limited to the effects described above, and effects not described may be clearly understood by those skilled in the art from the present specification and the attached drawings.

What is claimed is:

1. An aerosol generating device comprising:
a main body including a processor; and
a cartridge detachably coupled to the main body,
wherein the cartridge includes a reservoir storing an aerosol generating material, a heating structure configured to heat the aerosol generating material, and a wick configured to supply the aerosol generating material stored in the reservoir to the heating structure, and
the processor is configured to compare a first temperature of the heating structure with a preset threshold, stop power supply to the heating structure based on the first temperature being greater than or equal to the preset threshold, compare a second temperature of the heating structure detected after the power supply is stopped with the preset threshold, and supply power to the heating structure based on the second temperature being less than the preset threshold.

2. The aerosol generating device of claim 1, wherein
the main body further includes a puff sensor configured to detect a user's puff, and
the processor is further configured to obtain the first temperature of the heating structure according to detection of the user's puff through the puff sensor.

3. The aerosol generating device of claim 1, wherein the processor is further configured to supply power to the heating structure according to the second temperature obtained under a preset condition after the power supply is stopped.

4. The aerosol generating device of claim 1, wherein the processor is further configured to supply the power to the heating structure when the second temperature obtained within at least one of a preset temperature measurement time and a preset number of temperature measurements after the power supply is stopped is less than the preset threshold.

5. The aerosol generating device of claim 1, wherein the processor is further configured to supply the power to the heating structure when the second temperature obtained as the user's puff is detected after the power supply is stopped is less than the preset threshold.

6. The aerosol generating device of claim 1, wherein
the main body further includes a temperature sensor that is electrically connected to the heating structure when combined with the cartridge, and
the processor is further configured to measure electrical characteristics of the heating structure through the temperature sensor and convert the measured electrical characteristics into a temperature value.

7. The aerosol generating device of claim 6, wherein the electrical characteristic is a resistance value of the heating structure.

8. The aerosol generating device of claim 1, wherein the processor is further configured to supply power corresponding to the number of remaining puffs to the heating structure based on the second temperature being less than the preset threshold.

9. An aerosol generating device comprising:
a main body including a processor; and
a cartridge detachably coupled to the main body,
wherein the cartridge includes a reservoir storing an aerosol generating material, a heating structure configured to heat the aerosol generating material, and a wick configured to supply the aerosol generating material stored in the reservoir to the heating structure, and
the processor is configured to compare a temperature change amount of the heating structure with a preset threshold change amount, stop power supply to the heating structure based on the temperature change amount being greater than or equal to the preset threshold change amount, compare a temperature of the heating structure detected after the power supply is stopped with a preset threshold, and supply power to the heating structure based on the temperature being less than the preset threshold.

10. An operating method of an aerosol generating device, the operating method comprising:
comparing, by a processor included in a main body, a first temperature of a heating structure for heating an aerosol generating material in a cartridge detachably coupled to the main body with a preset threshold;
stopping, by the processor, power supply to the heating structure based on the first temperature being greater than or equal to the preset threshold;
comparing, by the processor, a second temperature of the heating structure detected after the power supply is stopped with the preset threshold, and
supplying, by the processor, power to the heating structure based on the second temperature being less than the preset threshold.

11. The operating method of claim 10, further comprising obtaining the first temperature of the heating structure according to detection of a user's puff through a puff sensor included in the main body.

12. The operating method of claim 10, wherein the supplying of the power to the heating structure based on the second temperature includes supplying the power to the heating structure when the second temperature obtained within at least one of a preset temperature measurement time and a preset number of temperature measurements after the power supply is stopped is less than the preset threshold.

13. The operating method of claim 10, wherein the supplying of the power to the heating structure based on the second temperature includes supplying the power to the heating structure when the second temperature obtained as the user's puff is detected after the power supply is stopped is less than the preset threshold.

14. The operating method of claim 10, further comprising measuring electrical characteristics of the heating structure through a temperature sensor included in the main body and converting the measured electrical characteristics into a temperature value.

15. The operating method of claim 10, wherein the supplying of the power to the heating structure based on the second temperature includes supplying power corresponding to the number of remaining puffs to the heating structure based on the second temperature being less than the preset threshold.
